(19) United States
(12) Patent Application Publication
(10) Pub. No.: US 2016/0180564 A1
(43) Pub. Date: Jun. 23, 2016

(54) INFORMATION DISPLAY DEVICE, DISTRIBUTION DEVICE, INFORMATION DISPLAY METHOD, AND NON-TRANSITORY COMPUTER READABLE STORAGE MEDIUM

(71) Applicant: YAHOO JAPAN CORPORATION, Tokyo (JP)

(72) Inventors: Daisuke KOBAYASHI, Tokyo (JP); Natsume SUZUOKI, Tokyo (JP); Shinya UCHIDA, Tokyo (JP); Keisuke KIMURA, Tokyo (JP)

(73) Assignee: YAHOO JAPAN CORPORATION, Tokyo (JP)

(21) Appl. No.: 14/965,164

(22) Filed: Dec. 10, 2015

(30) Foreign Application Priority Data
Dec. 19, 2014 (JP) 2014-258117

(51) Int. Cl. G06T 11/60; G06F 3/0485

(52) U.S. Cl. CPC G06T 11/60; G06F 3/0485

(57) ABSTRACT

According to one aspect of an embodiment, an information display device includes an arranging unit that arranges, in a column, first content and second content that is different from the first content such that an upper end of the first content is brought into contact with the lower end of the second content. The information display device includes a displaying unit that displays the first content and the second content at the position away from the upper end of the second content by a predetermined distance in the downward direction as the position of the upper end of a display area.

### CROSS-REFERENCE TO RELATED APPLICATION

The present application claims priority to and incorporates by reference the entire contents of Japanese Patent Application No. 2014-258117 filed in Japan on Dec. 19, 2014.

### BACKGROUND OF THE INVENTION

1. Field of the Invention

The present invention relates to an information display device, a distribution device, an information display method, and a non-transitory computer readable storage medium.

2. Description of the Related Art

Conventionally, there is a known technology for displaying various kinds of information on arbitrary information display devices, such as smart devices, i.e., smartphones, tablet personal computers (PCs), or the like, desktop PCs, or the like. As an example of this technology, there is a known technology that makes a user interested in content by displaying a predetermined content on a screen and changing display modes of the content in accordance with the operation performed by the user. For example, there is a known technology that displays a web page and content related to advertisement on a screen and expands, if a user performs a scroll operation on the web page, the area in which the content is displayed.
Patent Document 1: Japanese Laid-open Patent Publication No. 2014-049095

However, with the conventional technology described above, there may be a case in which an appeal effect of information related to the content is not always high. For example, with the conventional technology, when a scroll operation on a web page is performed, because the area in which the content is displayed is increased, the impression that a user who pays close attention to the web page gets from the content may possibly be worse.

### SUMMARY OF THE INVENTION

It is an object of the present invention to at least partially solve the problems in the conventional technology.

According to one aspect of an embodiment, an information display device includes an arranging unit that arranges, in a column, first content and second content that is different from the first content such that an upper end of the first content is brought into contact with the lower end of the second content. The information display device includes a displaying unit that displays the first content and the second content at the position away from the upper end of the second content by a predetermined distance in the downward direction as the position of the upper end of a display area.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating an example of a terminal device according to an embodiment;

FIG. 2 is a schematic diagram illustrating a configuration example of a distribution system according to the embodiment;

FIG. 3 is a schematic diagram illustrating a configuration example of an advertisement distribution server according to the embodiment;

FIG. 4 is a schematic diagram illustrating an example of information stored in an advertisement database according to the embodiment;

FIG. 5 is a schematic diagram illustrating a configuration example of a content distribution server according to the embodiment;

FIG. 6 is a schematic diagram illustrating a configuration example of a terminal device according to the embodiment;

FIG. 7 is a schematic diagram illustrating a first example of the amount of an offset used by the terminal device according to the embodiment;

FIG. 8 is a schematic diagram illustrating a second example of the amount of an offset used by the terminal device according to the embodiment;

FIG. 9 is a schematic diagram illustrating an example of a process in which the terminal device according to the embodiment releases a fixed display position;

FIG. 10 is a schematic diagram illustrating a process in which the terminal device according to the embodiment displays content that includes therein a moving image;

FIG. 11 is a flowchart illustrating an example of the flow of a display process performed by the terminal device according to the embodiment;

FIG. 12 is a schematic diagram illustrating a process in which the terminal device according to the embodiment displays two pieces of content so as to overlap each other;

FIG. 13 is a schematic diagram illustrating a process in which the terminal device according to the embodiment arranges the content; and

FIG. 14 is a hardware configuration diagram illustrating an example of a computer that implements the function performed by the advertisement distribution server.

### DETAILED DESCRIPTION OF THE PREFERRED EMBODIMENTS

A mode (hereinafter, referred to as an “embodiment”) for implementing an information display device, a distribution device, an information display method, and an information display program will be described in detail below with reference to the drawings. Note that the information display device, the distribution device, the information display method, and the information display program according to the present invention are not limited to the embodiment. Furthermore, note that in the embodiment described below, the same components are denoted by the same reference signs and an overlapping description is omitted.

### 1. Example of a Terminal Device 100

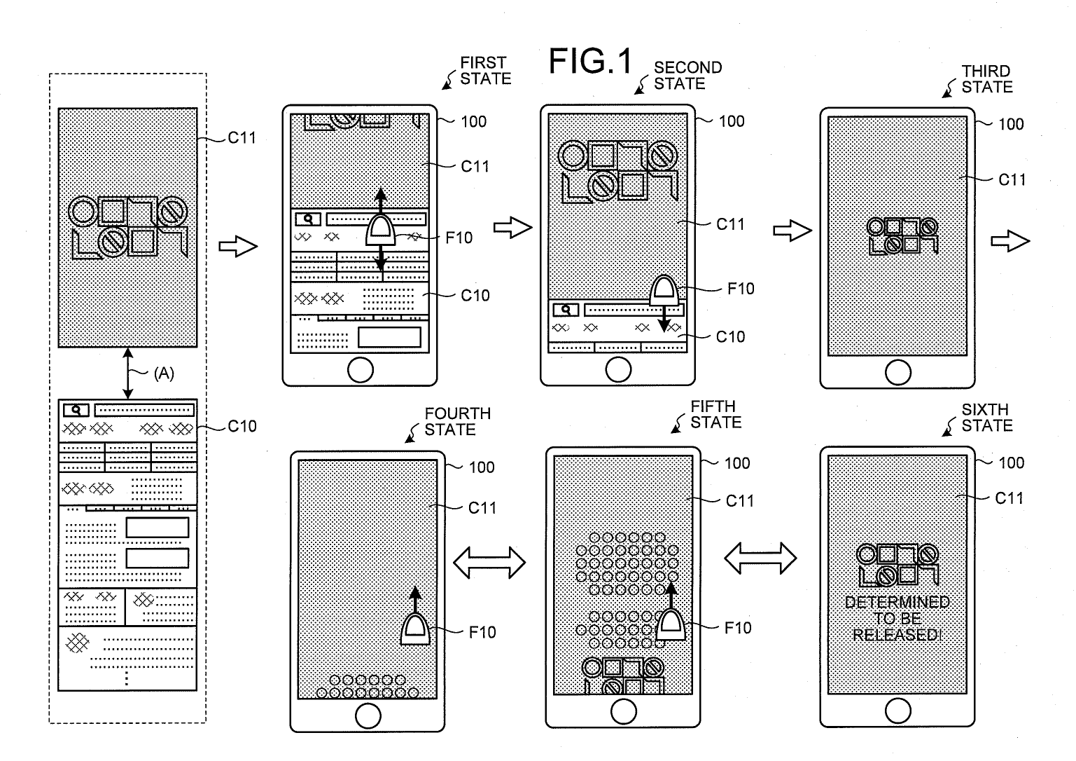

First, an example of a process performed by the terminal device 100 that is an example of an information display device will be described with reference to FIG. 1. FIG. 1 is a schematic diagram illustrating an example of a terminal device according to an embodiment. FIG. 1 illustrates an example in which a web page C10 and content C11 are displayed on the terminal device 100.

The terminal device 100 illustrated in FIG. 1 is a smart device, such as a smartphone, a tablet, or the like, and is a mobile terminal device that can communicates with an arbitrary server device via a wireless communication network, such as third generation (3G), Long Term Evolution (LTE), or the like. Furthermore, the terminal device 100 includes an output unit 130, such as a liquid crystal display or the like. It is assumed that a touch panel is used for the terminal device 100. Namely, a user of the terminal device 100 performs various kinds of operations by touching a display surface (hereinafter, may sometimes be referred to as a screen) of the output unit 130 by a user's finger or a stylus.

The web page C10 is a web page in which, for example, news, a weather forecast, the index or content of received mail, a photo viewer, and various other kinds of content are arranged and described in a Hyper Text Markup Language (HTML) or an Extensible Markup Language (XML). In a description below, it is assumed that the web page C10 is a web page of a so-called portal site. Furthermore, it is assumed that the web page C10 is a web page optimized for smart devices and assumed that the display size of the web page C10 in the horizontal direction is the same as the display size of the screen included in the terminal device 100 in the horizontal direction. Furthermore, it is assumed that the display size of the web page C10 in the vertical direction is longer than that of the output unit 130 included in the terminal device 100 in the vertical direction.

Furthermore, the web page C10 may also be content in which, for example, news, a weather forecast, the index or content of received mail, a photo viewer, and various other kinds of content are independently arranged in a tile shape and may also be content in which an operation, an update, or the like can be performed for each piece of content arranged in the tile shape. In such a case, the size of the arrangement position of each of the tiles arranged in the web page C10 may also be automatically changed for each tile or may also be changed in accordance with an operation performed by a user. The web page C10 may also be a web page described in a hypertext markup language (HTML), an extensible markup language (XML), or the like. In the web page C10 having this configuration, an input field that is used to input a search keyword, a link to other web pages, or the like are included.

The content C11 is content that is displayed together with the web page C10 and is, for example, content related to advertisement (hereinafter, referred to as advertisement content). Furthermore, the content C11 has content with the same size as that of the screen included in the terminal device 100.

Furthermore, the content C11 is content in which a display mode is changed depending on the state of the terminal device 100, the display position of the advertisement content C11, the operation performed by a user, or the like by using cascading style sheets (CSS), HTML 5, and scripts or the like in which other kinds of dynamic content can be described. For example, the content C11 is content that includes therein an image, a character, a graphic, a symbol, a moving image, or the like in which control of the display, the deletion, the expansion, the reduction, the movement, the rotation, the playback, the pause, or the like is performed by a user's operation. Furthermore, similarly to the web page C10, the content C11 may also be a web page described in HTML, XML, or the like.

The content related to advertisement mentioned here is assumed to be, in addition to profit-oriented advertisements or nonprofit-oriented advertisements, recruitment of volunteers, public service advertisements, notifications to the public, a part of information about the web page C10, or any other arbitrary content. Namely, for the content C11, images, moving images, characters, graphics, symbols, hyperlinks, and any other arbitrary content may be used, in addition to content that includes therein so-called advertisement related information, as long as the content causes a user to have an interest and widely delivers information included in the content C11 or information included in the content (for example, a landing page or the like) related to the content C11.

In a description below, it is assumed that, in an initial state, the content C11 is content in which a logo floats on a starry sky and, depending on the subsequent operation, the size of the logo is reduced or a character appears. The display mode of the content C11 will become apparent from the description below.

When the terminal device 100 receives distribution of the web page C10, the terminal device 100 sends a distribution request to an advertisement distribution server 20 that distributes content related to the advertisement. Then, when the terminal device 100 receives distribution of the content C11 as the content related to the advertisement from the advertisement distribution server 20, the terminal device 100 displays the web page C10 and the content C11.

### 2. Process Performed by the Terminal Device 100

At this point, in the conventional technology, when a scroll operation of the web page C10 is performed, an area in which predetermined content is displayed is expanded. However, in the conventional technology, because a display area of a web page becomes small due to expansion of the content area, if a user pays close attention to the web page, the impression of the user with respect to the content becomes degraded and thus there may be a case in which an appeal effect of the information related to the content is not appropriately be exhibited. In contrast, because the charging with respect to the advertisement distribution is performed with respect to the browsing or selection performed by a user, the content related to the advertisement is preferably be in a state in which the content attracts the user's attention.

### 2-1. Display Process

Thus, the terminal device 100 performs a display process described below. First, the terminal device 100 arranges the web page C10 and the content C11 in a column such that the upper end of the web page C10 is brought contact with the lower end of the content C11. For example, the terminal device 100 sets both the web page C10 and the content C11 as a single content (hereinafter, sometimes referred to as combined content).

Then, when the terminal device 100 displays the web page C10 and the content C11, the terminal device 100 displays the combined content by setting the position away from the upper end of the content C11 by a predetermined distance in the downward direction as the position of the upper end of the screen. Namely, the terminal device 100 displays the initial screen, in which the web page C10 and the content C11 are displayed, at the position of the web page C10 is set, as the reference, at the position of the upper end of the content C11 that is arranged in the upward direction of the screen of the web page C10, instead of the position of the upper end of the web page C10 as the reference.

For example, the terminal device 100 shifts the upper end of an area that is displayed and that is included in the combined content (hereinafter, sometimes be referred to as a display area) from the upper end of the content C11 in the downward direction. Then, the terminal device 100 displays the range included in the display area in the combined content as the initial screen that is used when a display of the combined content is started.

Here, the upper end of the web page C10 or the content C11 is the reference position when the web page C10 or the content C11 is displayed on a screen and is the end that is arranged at the top side of the screen when the web page C10 or the content C11 is displayed. Furthermore, the lower end of the web page C10 or the content C11 is the end that is arranged at the bottom side of the screen from among the ends occurring when the web page C10 or the content C11 is displayed on the screen. Furthermore, the screen in the upward direction is the direction in which, on the screen included in the terminal device 100, the upper end of the web page C10 or the content C11 is displayed, whereas the screen in the downward direction is the direction in which, on the screen, the lower end of the web page or the content C11 is displayed.

Furthermore, a predetermined distance that is used to shift a display area is an amount that is specified by an advertiser who, for example, registers or distributes the content C11 and is the amount of an offset that indicates the distance of the upper end of the initial screen to be shifted from the upper end of the content C11. For example, the amount of an offset is a value in which the upper end of the content C11, i.e., the upper end of the combined content, is used as a reference and is specified by the number of pixels, such as pixels; a value representing the distance, such as millimeters; the ratio with respect to the size of the screen; or the like.

For example, the terminal device 100 receives, together with the distribution of the content C11, the amount of an offset by using the upper end of the content C11 as the reference. In such a case, the terminal device 100 specifies the position away from the upper end of the combined content by the amount of an offset in the downward direction and displays an initial screen by using the specified position as the upper end of the display area.

### 2-2. Arrangement of the Web Page C10 and the Content C11

Here, when the web page C10 is displayed by using a web browser or the like, the vertex at the upper left corner of the web page C10 is set as the reference point and then the web page C10 is displayed such that the subject reference point matches the upper left corner of the screen. Consequently, in order to display the content C11 on the screen of the web page C10 in the upward direction, a complicated process is needed.

For example, it is conceivable to perform a process of setting both a frame in which the web page C10 is displayed and a frame in which the content C11 is displayed and changing, while the size of each frame is changed in accordance with a scroll operation, the position of the area of the web page C10 displayed in the frame and the position of the area of the content C11 displayed in the frame. However, in this process, the processing load applied to the terminal device 100 is increased.

Thus, when the terminal device 100 receives distribution of both of the web page C10 and the content C11, the terminal device 100 displays a combined content in which the upper end of the web page C10 and the lower end of the content C11 are arranged so as to overlap each other. When such a process is performed, the web browser displays the combined content, i.e., both of the web page C10 and the content C11, by using the vertex at the upper left corner of the combined content as the reference point. Consequently, when the terminal device 100 displays the combined content, the terminal device 100 can display, as the initial screen, both of the web page C10 and the content C11, only by setting the amount of an offset on a browser or the like.

Here, it is conceivable that, at the timing at which a display of the web page C10 is started, i.e., at the timing at which an initial screen is displayed, a user of the terminal device 100 has a low interest in the web page C10 compared with the timing after the user started browsing the web page C10. Consequently, by displaying both the web page C10 and the content C11 on the initial screen, the terminal device 100 can prevent the impression on the content C11 from being degraded.

Furthermore, if the user of the terminal device 100 becomes aware of the content C11 and becomes interested in the content C11, it is conceivable that the user performs a scroll operation in which the web page C10 is scrolled in the downward direction on the screen. If this operation is performed, the terminal device 100 scrolls the combined content in the downward direction on the screen (i.e., moves the display area of the combined content in the upward direction) and increases the ratio of the content C11 occupied in the display area. Consequently, the terminal device 100 can improve an appeal effect of information related to the content C11 without degrading the impression on the content C11.

Furthermore, if the user desires to browse the web page C10 without having an interest in the content C11, it is conceivable that the user performs a scroll operation in which the web page C10 is scrolled in the upward direction on the screen. If this operation is performed, the terminal device 100 scrolls the combined content in the upward direction on the screen (i.e., moves the display area of the combined content in the downward direction) and increases the ratio of the web page C10 occupied in the display area. Consequently, because the terminal device 100 does not inhibits the act of a user browsing the web page C10, the terminal device 100 can prevent the degradation of the impression with respect to the content C11.

### 2-3. Display of the Content C11

Here, in order to improve the appeal effect of the information related to the content C11, the terminal device 100 may also display the content C11 in which a display mode can be changed in accordance with an operation performed by a user. For example, the terminal device 100 may also perform, in accordance with an operation performed by a user, the display, the deletion, the expansion, the reduction, the movement, the rotation, the playback, the pause, or the like of the character, the graphic, the symbol, or the moving image included in the content C11. More specifically, if a user taps the content C11, the terminal device 100 may also play back the moving images included in the content C11.

Furthermore, if a user performs a scroll operation in the downward direction and tries to display the content C11, it is conceivable that the user is interested in the content C11. Consequently, if the user performs the scroll operation in the downward direction and the ratio of the content C11 occupied in the display area exceeds a predetermined threshold, the terminal device 100 may also start the playback of the moving image included in the content C11.

Furthermore, if the ratio of the content C11 occupied in the display area exceeds a predetermined threshold, the terminal device 100 may also automatically changes the position of the display area until the entire content C11 is displayed. Namely, if it is determined that the user is interested in the content C11, the terminal device 100 may also display the content C11 on the entire screen.

At this point, if a scroll operation in the upward direction is performed, the terminal device 100 may also display the content C11 that is used to change the display modes. For example, the terminal device 100 may also display, in accordance with the scroll operation in the upward direction, the content C11 with character strings flowing from the downward direction to the upward direction on the screen. However, if the scroll operation in the upward direction is performed, the ratio of the content C11 occupied in the display area is reduced.

Thus, if the scroll operation or the position of the display area is automatically changed and the entire content C11 is consequently displayed, the terminal device 100 may also fix the position of the display area. Then, after the terminal device 100 fixed the position of the display area, if a scroll operation in the upward direction is performed, the terminal device 100 may also change the display mode of the content C11 in accordance with the subject scroll operation. Furthermore, if a predetermined operation is performed after the terminal device 100 fixed the position of the display area, the terminal device 100 may also release the fixed position of the display area.

### 2-4. Example of the Process Performed by the Terminal Device 100

In the following, an example of the display process performed by the terminal device 100 will be described with reference to FIG. 1. Furthermore, in a description below, an example of the display process performed by the terminal device 100 is described by dividing the states into a first state to a sixth state.

First, the terminal device 100 receives distribution of the web page C10 and the content C11. Furthermore, in addition to the distribution of the content C11, the terminal device 100 receives distribution of the specified amount of an offset. In such a case, as indicated by (A) illustrated in FIG. 1, the terminal device 100 creates combined content by arranging the content C11 and the web page C10 in a column such that the lower end of the content C11 is brought contact with the upper end of the web page C10. Furthermore, the terminal device 100 may also use, as the combined content, content that is different from the web page C10 and the content C11; may also use, as the combined content, content obtained by inserting the content C11 into the upper end of the web page C10; or may also use, as the combined content, content obtained by inserting the web page C10 into the lower end of the content C11.

Then, the terminal device 100 shifts the position of the display area of the combined content to the position away from the upper end of the combined content by the amount of an offset in the downward direction and then displays the range included in the display area. For example, if the terminal device 100 receives an instruction of the amount of an offset indicating that the display area is to be shifted by an amount corresponding to about ⅗ of the content C11, the terminal device 100 displays, as indicated by the first state, a portion of the content C11 on the upper side of the screen and displays a portion of the web page C10 on the lower side of the screen. More specifically, the terminal device 100 displays, on the screen, the content C11 from the lower with the size about ⅖ of the content C11 end and displays, on the screen, the web page C10 from the upper end with the size about ⅗ of the web page C10.

At this time, the terminal device 100 moves the combined content in accordance with the operation performed by a user. For example, if the terminal device 100 receives a scroll operation performed by a finger F10 of the user, the terminal device 100 scrolls the combined content in accordance with the scroll operation. For example, if a user who is not interested in the content C11 performs a scroll operation in the upward direction, the terminal device 100 scrolls the combined content in the upward direction and expands the size of the area in which the web page C10 is displayed.

In contrast, if the user who became aware of the content C11 due to the display indicated by the first state performs a scroll operation in the downward direction, the terminal device 100 scrolls, as indicated by the second state illustrated in FIG. 1, the combined content in the downward direction and expands the size of the area in which the content C11 is displayed.

Furthermore, the terminal device 100 changes the display mode of the content C11 in accordance with the operation performed by the user. For example, if the ratio of the area occupied by the content C11 in the display area exceeds a predetermined threshold (for example, ⅗) due to the scroll operation performed by the user, the terminal device 100 performs a playback or the like of the moving image included in the content C11. Specifically, as indicated by the third state, the terminal device 100 gradually reduces the size of the logo displayed inside the content C11.

Furthermore, as indicated by the third state illustrated in FIG. 1, if the entire content C11 is displayed, the terminal device 100 fixes the combined content. For example, the terminal device 100 fixes the position of the display area. Then, even if a scroll operation in the upward direction is performed in the third state illustrated in FIG. 1, the terminal device 100 does not scroll the combined content and changes the display mode of the content C11 in accordance with the subject scroll operation. For example, if the scroll operation in the upward direction is performed in the third state illustrated in FIG. 1, as indicated by the fourth state illustrated in FIG. 1, the terminal device 100 changes, in accordance with the scroll operation, the display mode of the content C11 in a mode in which the character strings are moved from the downward direction on the screen to the upward direction on the screen.

Furthermore, if the user continues the scroll operation in the upward direction, as indicated by the fifth state illustrated in FIG. 1, the terminal device 100 moves, in accordance with the scroll operation, the character strings from the downward direction on the screen to the upward direction on the screen and deletes the character strings that were moved to the upper side of the screen above a predetermined display position. Furthermore, if the user further performs a scroll operation in the upward direction, as indicated by the sixth state illustrated in FIG. 1, the terminal device 100 displays the logo subsequent to the character strings.

Furthermore, if the user performs a scroll operation in the downward direction during the fourth state to the sixth state, the terminal device 100 may also move the logo in the downward direction in accordance with the subject scroll operation and move, on the screen, the character strings from the upward direction toward the downward direction. For example, if the user performs the scroll operation in the downward direction in the sixth state, the terminal device 100 may also change the display mode from the sixth state to the fifth state and change from the fifth state to the fourth state in accordance with the subject scroll operation.

Furthermore, when the terminal device 100 displays the logo in a mode indicated by the sixth state illustrated in FIG. 1, if the user selects the content C11, the terminal device 100 may also display a landing page. Furthermore, in accordance with the timing at which the user selects the content C11, the terminal device 100 may also perform control of determining whether to transit to a landing page, control selection of a landing page, or the like.

Furthermore, if the user performs a predetermined operation during the time period between the third state and the sixth state illustrated in FIG. 1, the terminal device 100 may also release the fixed display position of the combined content. For example, if a scroll operation is performed at a predetermined position on the screen, such as a case in which a scroll operation is performed from the lower end of the screen to the upward direction, the terminal device 100 may also release the fixed display position and scroll the combined content in accordance with the scroll operation in the upward direction. Furthermore, if the terminal device 100 displays, on the content C11, an icon that is used to instruct the release of the fixed display position and if the user selects the icon, the terminal device 100 may also release the fixed display position. Furthermore, as indicated by the sixth state illustrated in FIG. 1, if the terminal device 100 changes the mode of the content C11 to the end by the operation performed by the user, the terminal device 100 may also release the fixed display position. Namely, the terminal device 100 may also fix the display position and release the fixed display position by using an arbitrary condition as a trigger.

As described above, the terminal device 100 creates combined content in which the upper end of the web page C10 and the lower end of the content C11 are arranged so as to overlap each other. Then, the terminal device 100 displays an initial screen in which the upper end of the combined content, i.e., the position away from the upper end of the content C11 by a predetermined amount of an offset in the downward direction, is set as the upper end of the initial screen.

Consequently, the terminal device 100 can display the web page C10 in an initial state and display the content C11 on the upper side of the web page C10 without performing a complicated process. Consequently, for example, the terminal device 100 can provide an awareness of the content C11 while preventing the impression of the user with respect to the content C11 from being degraded and leads users who are interested in the content C11 into the content C11. Consequently, the terminal device 100 can improve the appeal of information related to the content C11.

### 2-5. About Execution Subject

Although, a description has been omitted in the above description, the terminal device 100 can implement the display process described above by an arbitrary method. For example, the terminal device 100 may also implement the display process described above by downloading the application to be executed by the terminal device 100 and performing the application at an arbitrary timing.

Furthermore, at the same time of distribution of the web page C10 and the content C11, the terminal device 100 receives distribution of control information that executes the display process described above. Then, the terminal device 100 performs the display process described above in accordance with the control information. In the following, a description will be given of the terminal device 100 and the like that perform the display process illustrated in FIG. 1 in accordance with the control information.

### 3. Configuration of a Distribution System

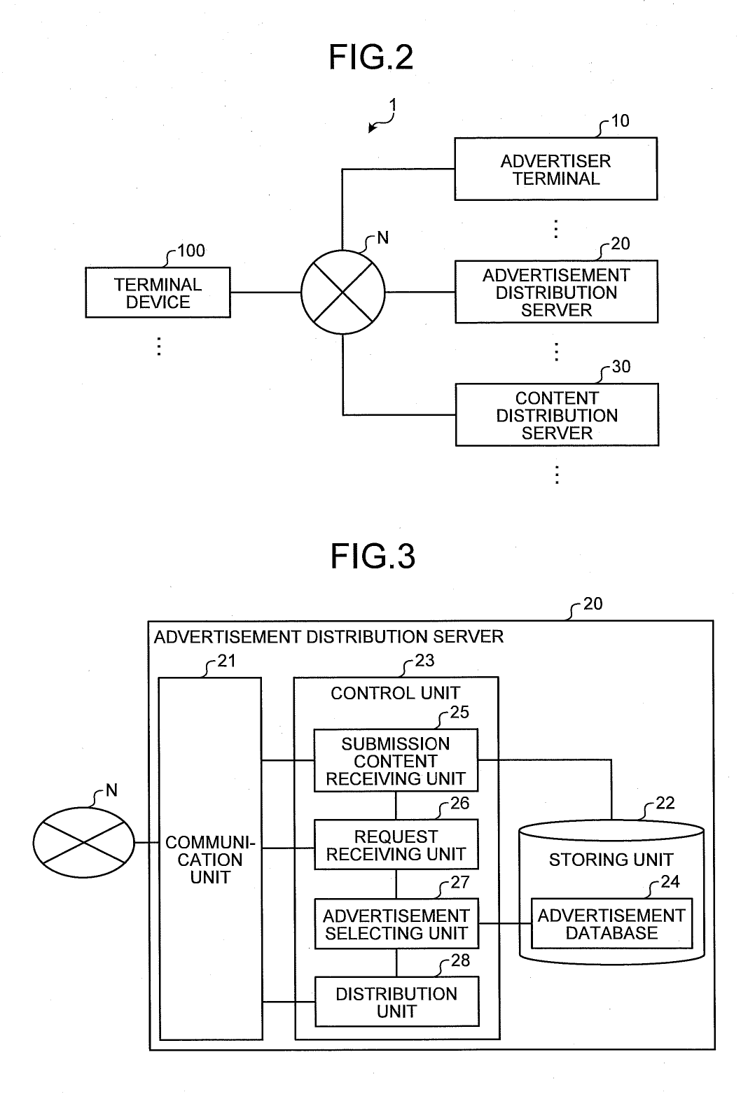

In the following, a description will be given of the terminal device 100 and the like that implement the display process described above. First, the configuration of a distribution system 1 according to the embodiment will be described with reference to FIG. 2. FIG. 2 is a schematic diagram illustrating a configuration example of a distribution system according to the embodiment. As illustrated in FIG. 2, the distribution system 1 includes the terminal device 100, an advertiser terminal 10, the advertisement distribution server 20, and a content distribution server 30. The terminal device 100, the advertiser terminal 10, the advertisement distribution server 20, and the content distribution server 30 are connected via a network N such that they can communicate with each other by using wired connection or wireless connection. Furthermore, in the distribution system 1 illustrated in FIG. 2, a plurality number of the terminal devices 100, a plurality number of the advertiser terminals 10, a plurality number of the advertisement distribution servers 20, and a plurality number of the content distribution servers 30 may also be included.

The terminal device 100 is an information processing device that is used by a user who browses a web page. For example, the terminal device 100 is a mobile phone, such as a smartphone, or the like, a tablet terminal, a personal digital assistance (PDA), a desktop personal computer (PC), a notebook PC, or the like. The terminal device 100 acquires, in accordance with an operation performed by a user, the web page C10 from the content distribution server 30 and then displays the acquired web page C10. Furthermore, if an acquisition instruction, which will be described later, is included together with the web page C10, the terminal device 100 acquires the content C11 from the advertisement distribution server 20. Furthermore, if the terminal device 100 receives, from the advertisement distribution server 20, distribution of the control information that implements the display process described above, the terminal device 100 performs the operation in accordance with the control information and implements the display process.

The advertiser terminal 10 is an information processing device that is used by an advertiser. For example, the advertiser terminal 10 is a desktop PC, a notebook PC, a tablet terminal, a mobile phone, a PDA, or the like. The advertiser terminal 10 submits, in accordance with the operation performed by the advertiser, the content C11 or the like as the advertisement content to the advertisement distribution server 20. For example, the advertiser terminal 10 submits, as the advertisement content, the content C11 to the advertisement distribution server 20. Furthermore, the advertiser terminal 10 submits, as the content C11, a still image, a moving image, text data, a Uniform Resource Locator (URL) that is used to acquire a landing page, or the like to the advertisement distribution server 20.

Furthermore, the advertiser may possibly request an agency to submit the advertisement content. In this case, the submission of the advertisement content to the advertisement distribution server 20 is performed by the agency. In the following description, it is assumed that the expression “advertiser” is a concept including not only the advertiser but also the agency, and the expression “advertiser terminal” is a concept including not only the advertiser terminal 10 but also the agency's device used by the agency.

The advertisement distribution server 20 is a server device that distributes the advertisement content submitted from the advertiser terminal 10. For example, when the advertisement distribution server 20 receives a distribution request of the advertisement content from the terminal device 100, the advertisement distribution server 20 performs the matching of the user and the advertisement content from the location of the terminal device 100, the attributes of the user, or the like and then distributes, to the terminal device 100, the advertisement content that is the distribution target from the result of the matching. Furthermore, the advertisement distribution server 20 distributes, to the terminal device 100 together with the content C11 that is the advertisement content, the control information that is used to implement the display process described above. The control information is described in, for example, a script language, such as JavaScript (registered trademark) or Cascading Style Sheets (CSS), or the like. Furthermore, the amount of an offset in the display area may also be distributed as the control information or may also be distributed as information separated from the control information.

The content distribution server 30 is a web server that distributes the web page C10 to the terminal device 100. For example, the content distribution server 30 distributes, to the terminal device 100, the web page C10 including tiles including various kinds of information related to a portal site, a news site, an auction site, a weather forecast site, a shopping site, a finance (stock) site, a route search site, a map providing site, a tourism site, a restaurant introduction site, a web blog, or the like. Furthermore, the content distribution server 30 may also be a server that distributes a web page, such as a portal site, in which various kinds of information are arranged.

At this point, an acquisition instruction is included in the web page C10 distributed by the content distribution server 30. For example, the URL of the advertisement distribution server 20 or the like is described, as the acquisition instruction, in an HTML file or the like that forms the web page C10. In this case, the terminal device 100 acquires the content C11 from the advertisement distribution server 20 as the advertisement content by accessing the URL described in the HTML file or the like.

Furthermore, the various kinds of data distributed from the content distribution server 30 to the terminal device 100 are, in practice, the HTML files or the images that form a web page, moving images displayed together with the web page, or the like.

### 4. Configuration of the Advertisement Distribution Server

In the following, the configuration of the advertisement distribution server 20 according to the embodiment will be described with reference to FIG. 3. FIG. 3 is a schematic diagram illustrating a configuration example of an advertisement distribution server according to the embodiment. As illustrated in FIG. 3, the advertisement distribution server 20 includes a communication unit 21, a storing unit 22, and a control unit 23.

The communication unit 21 is implemented by, for example, a network interface card (NIC) or the like. Furthermore, the communication unit 21 is connected via a network N in a wired or a wireless manner and sends and receives information to and from the terminal device 100, the advertiser terminal 10, and the content distribution server 30.

The storing unit 22 is implements by a semiconductor memory device, such as a random access memory (RAM), a flash memory, and the like, or a storage device, such as a hard disk, an optical disk, and the like. Furthermore, the storing unit 22 stores therein an advertisement database 24 that is the database that stores therein various kinds of information related to the advertisement content submitted from the advertiser terminal 10.

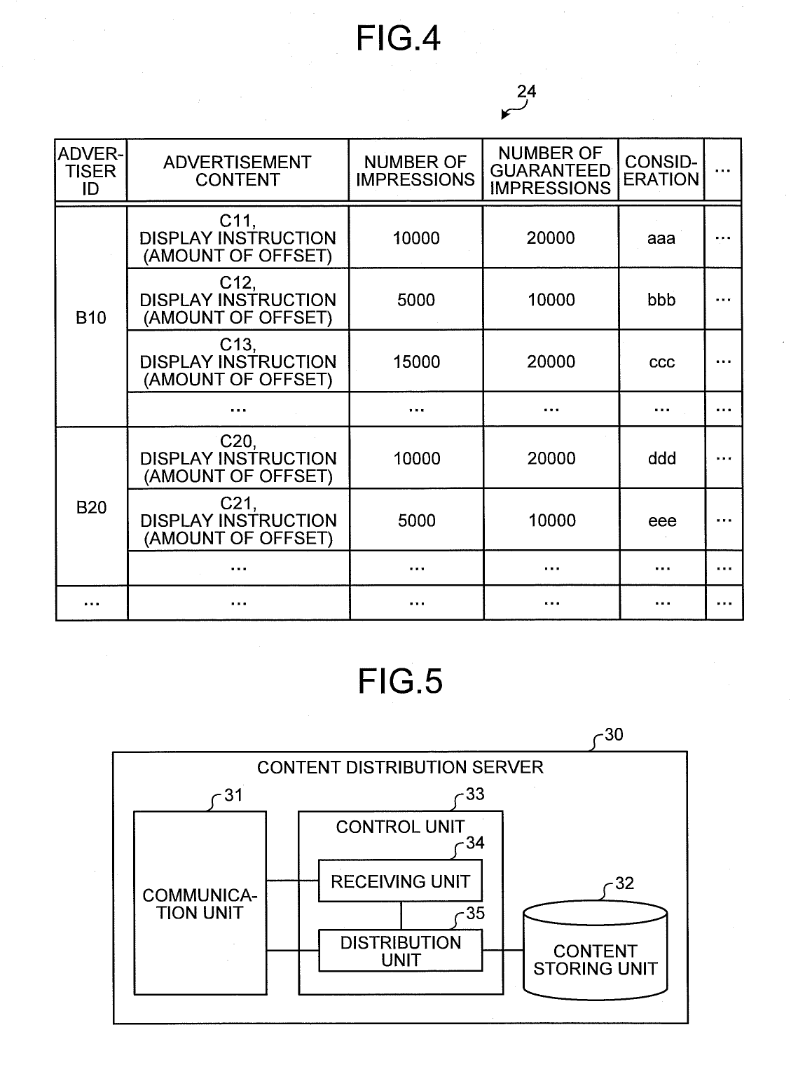

Here, FIG. 4 is a schematic diagram illustrating an example of information stored in an advertisement database according to the embodiment. In the example illustrated in FIG. 4, the advertisement database 24 includes items, such as an advertiser ID, advertisement content, the number of impressions, the number of guaranteed impressions, and a consideration. Furthermore, the advertisement database 24 may further store therein information that is used to perform the matching of content and a user or information, such as a click through rate (CTR).

The “advertiser ID” indicates identification information for identifying an advertiser or the advertiser terminal 10. The “advertisement content” indicates the content submitted from the advertiser terminal 10, i.e., the content, such as the content C11, related to an advertisement. Furthermore, FIG. 4 illustrates an example in which conceptual information, such as “C11” to “C21” are stored in the “advertisement content”; however, in practice, the URL in which each piece of the content is located, or a file path name indicating a storage location of the content, such as an individual image, a moving image, an audio together with an image, text data, game data, an advertisement in a game format, and the like that are used to notify a user of the common information are stored.

In addition to the content C11, a display instruction indicating a change in a display mode of the content C11 is registered as the advertisement content in the advertisement database 24. In the display instruction, the amount of an offset indicates an amount that is used when a display area is shifted in an initial state. For example, in the advertisement database 24, the number of pixels indicating the amount of an offset, such as “300 pixel”, or a ratio of the offset with respect to the display screen, such as “30 percentages” is registered as the amount of an offset.

The display instruction includes therein information indicating an operation performed by a user and the state of the terminal device 100, which are used, when the content C11 is displayed, as a trigger for a change in a display mode, a trigger for a fixation or a release of the position of the display area, a trigger for transition to a landing page. For the display instruction, for example, when an advertiser registers advertisement content, an arbitrary setting is performed by an advertiser.

The “number of impressions” indicates the number of times advertisement content is displayed. Furthermore, the “number of guaranteed impressions” indicates the number of displays of the advertisement content guaranteed on a consideration. Furthermore the “consideration” indicates a fee to be paid by the advertiser when the advertising content is displayed by the “number of guaranteed impressions”. Namely, the advertisement distribution server 20 is a server that distributes content related to an advertisement in an impression guaranteed form.

Namely, FIG. 4 illustrates an example in which an advertiser identified by the advertiser ID “B10” has submitted the content C11 as the advertisement content. Furthermore, FIG. 4 illustrates an example in which the number of impressions of the advertisement content “C11” is “10000”, the number of guaranteed impressions is “20000”, and the amount charged for the display of the content “C11” by the number of guaranteed impressions is “aaa”.

Furthermore, when content related to an advertisement is delivered in a pay per click form in which a fee is charged every time the advertisement content is selected, the number of times the content is selected, an amount of fee when the content is selected, and the like are registered in the advertisement database 24. Furthermore, when the distribution request is received, the advertisement content is selected in a bidding form, and, when the selected advertisement content is delivered, a bidding price serving as an advertising fee set by the advertiser as compensation per impression, a CTR, and the like are registered in the advertisement database 24.

Referring back to FIG. 3, the description will be continued. The control unit 23 is implemented by, for example, a central processing unit (CPU), a micro processing unit (MPU), or the like executing various kinds of programs, which are stored in a storage device in the advertisement distribution server 20, by using a RAM as a work area. Furthermore, the control unit 23 is implemented by, for example, an integrated circuit, such as an application specific integrated circuit (ASIC), a field programmable gate array (FPGA), or the like.

As illustrated in FIG. 3, the control unit 23 includes a submission content receiving unit 25, a request receiving unit 26, an advertisement selecting unit 27, and a distribution unit 28 and implements or executes a function or an operation of information processing that will be described below. The internal configuration of the control unit 23 is not limited to the configuration illustrated in FIG. 3, and may be any other configuration as long as information processing, which will be described later, is performed. Furthermore, the connection relation among the processing units included in the control unit 23 is not limited to the connection relation illustrated in FIG. 3 and may be any other connection relation.

The submission content receiving unit 25 receives submission of the advertisement content from the advertiser terminal 10. Specifically, the submission content receiving unit 25 receives submission of the advertisement content together with an instruction of a consideration. Furthermore, the submission content receiving unit 25 receives the content C11 and a display instruction. In this case, the submission content receiving unit 25 registers the content C11 and the display instruction in the advertisement database 24 together with both of the advertiser ID and the value of the received consideration.

The request receiving unit 26 receives an acquisition request of advertisement content from the terminal device 100. For example, the request receiving unit 26 receives an HTTP request as the acquisition request of the advertisement content.

If the acquisition request of the advertisement content is received by the request receiving unit 26, the advertisement selecting unit 27 selects advertisement content that is a distribution candidate from the advertisement database 24. For example, the advertisement selecting unit 27 performs, on the basis of the position of the terminal device 100 and the attributes of a user, matching of the advertisement content that becomes the distribution target from the advertisement content registered in the advertisement database 24. In the matching, advertisement content is selected such that the number of impressions is greater than the number of guaranteed impressions. For example, the advertisement selecting unit 27 selects, with priority, advertisement content in which a difference between the number of guaranteed impressions and the number of impressions is the greatest. Furthermore, the advertisement selecting unit 27 may also select, with priority, advertisement content in which a bidding price or a CTR is high or advertisement content in which both a bidding price and a CTR are high. Then, the advertisement selecting unit 27 outputs, to the distribution unit 28, the advertisement content that has been selected as the distribution target.

Furthermore, is a web page is a search page, the advertisement selecting unit 27 may also use an advertisement distribution technique called a search advertising that extracts advertisement content matching a search keyword specification the search page. Furthermore, the advertisement selecting unit 27 may also use an advertisement distribution technique called a targeting distribution that extracts advertisement content that matches the attribute information (psychographic attributes, demographic attributes, or the like) of the user.

The distribution unit 28 distributes control information to the terminal device 100 together with the advertisement content that is selected by the advertisement selecting unit 27. Specifically, when the distribution unit 28 receives the advertisement content selected by the advertisement selecting unit 27, the distribution unit 28 extracts A display instruction included in the received advertisement content. Then, the distribution unit 28 creates control information for allowing the terminal device 100 to execute the display process indicated by the extracted display instruction. Then, the distribution unit 28 distributes the created control information and the advertisement content to the terminal device 100.

### 5. Configuration of the Content Distribution Server

In the following, the content distribution server 30 according to the embodiment will be described with reference to FIG. 5. FIG. 5 is a schematic diagram illustrating a configuration example of the content distribution server according to the embodiment. As illustrated in FIG. 5, the content distribution server 30 includes a communication unit 31, a content storing unit 32, and a control unit 33.

The communication unit 31 is implemented by, for example, a network interface card (NIC) or the like. Furthermore, the communication unit 31 is connected via a network N in a wired or a wireless manner and sends and receives information to and from the terminal device 100 and the advertisement distribution server 20.

The content storing unit 32 is implements by a semiconductor memory device, such as a RAM, a flash memory, and the like, or a storage device, such as a hard disk, an optical disk, and the like. Furthermore, the content storing unit 32 stores therein a web page that is an example of content. For example, the content storing unit 32 stores therein an HTML file that forms a web page, a still image or a moving image displayed on a web page.

The control unit 33 is implemented by, for example, the CPU, the MPU, or the like executing various kinds programs (corresponding to an example of a distribution program), which are stored in a storage device in the content distribution server 30, by using a RAM as a work area. Furthermore, the control unit 33 is implemented by, for example, an integrated circuit, such as an ASIC, an FPGA, or the like.

As illustrated in FIG. 5, the control unit 33 includes a receiving unit 34 and a distribution unit 35 and implements or executes a function or an operation of information processing that will be described below. The internal configuration of the control unit 33 is not limited to the configuration illustrated in FIG. 5, and may be any other configuration as long as information processing, which will be described later, is performed. Furthermore, the connection relation among the processing units included in the control unit 33 is not limited to the connection relation illustrated in FIG. 5 and may be any other connection relation.

The receiving unit 34 receives an acquisition request of a web page from the terminal device 100. For example, the receiving unit 34 receives an HTTP request as an acquisition request of a web page.

When an acquisition request of a web page is received by the receiving unit 34, the distribution unit 35 distributes the web page to the terminal device 100. Specifically, the distribution unit 35 acquires, from the content storing unit 32, a web page targeted for the acquisition request and distributes the acquired web page to the terminal device 100.

Furthermore, the distribution unit 35 creates the web page C10 and distributes the created web page C10 to the terminal device 100. In this case, when the terminal device 100 receives the web page C10, the terminal device 100 sends, to the advertisement distribution server 20, a distribution request of the advertisement and displays the advertisement content that is received as a response. Then, the terminal device 100 performs, in accordance with an operation performed by a user, a display process that changes advertisement content.

### 6. Configuration of the Terminal Device

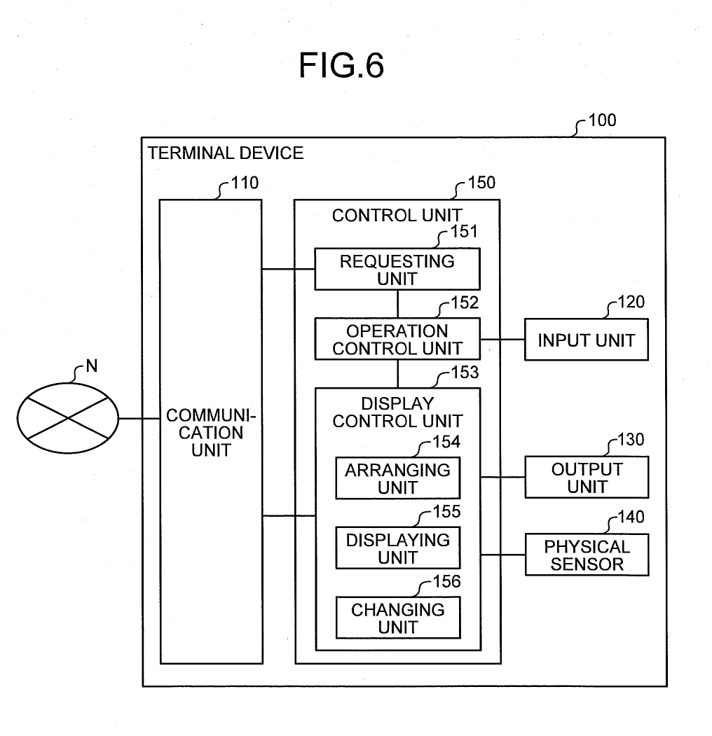

In the following, the configuration of the terminal device 100 according to the embodiment will be described with reference to FIG. 6. FIG. 6 is a schematic diagram illustrating a configuration example of a terminal device according to the embodiment. As illustrated in FIG. 6, the terminal device 100 includes a communication unit 110, an input unit 120, the output unit 130, a physical sensor 140, and a control unit 150.

The communication unit 110 is implemented by, for example, a NIC or the like. Furthermore, the communication unit 110 is connected via a network N in a wired or a wireless manner and sends and receives information to and from the advertisement distribution server 20 and the content distribution server 30.

The input unit 120 is an input device that receives various kinds of operations from a user. For example, the input unit 120 is implemented by a keyboard, a mouse, or the like. The output unit 130 is a display device for displaying various kinds of information. For example, the output unit 130 is implemented by a liquid crystal display or the like. If a touch panel is used for the terminal device 100, the input unit 120 is integrated with the output unit 130. Furthermore, in a description below, the output unit 130 is sometimes referred to as a screen.

The physical sensor 140 is a sensor that detects a physical state of the terminal device 100. For example, the physical sensor 140 is a gyro sensor that measures inclinations of the terminal device 100 in three axial directions. Furthermore, the physical sensor 140 is not limited to the gyro sensor, but an arbitrary sensor, such as an acceleration sensor, a temperature sensor, a volume sensor, a brightness sensor, or the like, may also be used.

control unit 150 is implemented by, for example, a central processing unit (CPU), a micro processing unit (MPU), or the like executing various kinds of programs (corresponding to an example of a display program), which are stored in a storage device in the terminal device 100, by using a RAM as a work area. For example, these various kinds programs correspond to an application program called a web browser. Furthermore, the control unit 150 is implemented by, for example, an integrated circuit, such as an ASIC, an FPGA, or the like.

As illustrated in FIG. 6, the control unit 150 includes a requesting unit 151, an operation control unit 152, and a display control unit 153 and implements or executes a function or an operation of information processing that will be described below. The internal configuration of the control unit 150 is not limited to the configuration illustrated in FIG. 6 and may be any other configuration as long as information processing, which will be described later, is performed. Furthermore, the connection relation among the processing units included in the control unit 150 is not limited to the connection relation illustrated in FIG. 6 and may be any other connection relation.

If the requesting unit 151 receives the URL of the web page C10 from the operation control unit 152, the requesting unit 151 sends, to the content distribution server 30, an acquisition request of the web page C10 indicated by the received URL. Furthermore, if the acquisition instruction is included in the web page received from the content distribution server 30, the requesting unit 151 sends the acquisition request of the advertisement content to the advertisement distribution server 20.

The operation control unit 152 performs various kinds of control in accordance with the operation performed by a user received via the input unit 120. For example, if a user performs, on the input unit 120, an operation of displaying the web page C10, the operation control unit 152 outputs the URL of the web page C10 targeted for the display to the requesting unit 151. Furthermore, the operation control unit 152 outputs, to the display control unit 153, the content of the operation, such as a scroll operation, a tap operation, or the like, received via the input unit 120 performed by the user.

The display control unit 153 performs a process of displaying the received web page and the advertisement content to the output unit 130. For example, the control unit 150 executes the control information distributed together with the advertisement content, whereby the display control unit 153 operates, as illustrated in FIG. 6, as an arranging unit 154, a displaying unit 155, and a changing unit 156 and performs the display process. The arranging unit 154, the displaying unit 155, and the changing unit 156 is implemented by, for example, the CPU, the MPU, or the like executing the control information by using a RAM as a work area.

The arranging unit 154 creates combined content in which the web page C10 and the content C11 are arranged in a column such that the upper end of the web page C10 is brought into contact with the lower end of the content C11. For example, if the arranging unit 154 receives the web page C10 and the content C11 in which the display mode is changed in accordance with the operation performed by a user, the arranging unit 154 analyzes the description of each of the web page C10 and the content C11 and creates combined content in which the content C11 is arranged on the upper side of the content arranged inside the web page C10 on the screen. Similarly to the web page C10 and the content C11, the combined content may also be described in an HTML or an XML. Then, the arranging unit 154 outputs the created combined content to the displaying unit 155.

The displaying unit 155 displays the web page C10 and the content C11 at the position away from the upper end of the content C11 by a predetermined amount of an offset in the downward direction as the position of the upper end. Specifically, if the displaying unit 155 displays an initial screen from which a display of the combined content is started, the displaying unit 155 sets the position away from the upper end of the content C11 by a predetermined distance in the downward direction on the screen as the upper end of the display area of the combined content and displays the range in the display area included in the combined content.

For example, if the displaying unit 155 receives combined content from the arranging unit, the displaying unit 155 shifts the position of the display area such that the upper end of the display area, which is the displayed area to be displayed in the combined content, corresponds to the position away from the upper end of the combined content by the specified amount of an offset in the lower end direction of the combined content. Then, the displaying unit 155 displays, as the initial screen, the range included in the display area in the combined content.

Furthermore, the displaying unit 155 changes the position of the display area in accordance with the operation performed by the user. For example, if a user performs a scroll operation in the upward direction, the displaying unit 155 moves the position of the display area in the lower end direction of the combined content, whereas a user performs a scroll operation in the downward direction, the displaying unit 155 moves the position of the display area in the upward direction of the combined content.

Furthermore, if the position of the display area is changed and the entire content C11 is consequently displayed, the displaying unit 155 fixes the position of the display area and continues to display the content C11 without changing the position of the display area even if a scroll operation is performed. In contrast, if a predetermined operation, such as a scroll operation in the upward direction from the lower end of the screen, is performed, the displaying unit 155 releases the fixed position of the display area and changes the position of the display area in accordance with the scroll operation.

Furthermore, if the content C11 is selected by a user, the displaying unit 155 displays the landing page associated with the content C11. The condition, used as a trigger, in which the displaying unit 155 displays the landing page is not limited thereto and any arbitrary condition may also be set. For example, the displaying unit 155 may also display the landing page when the position of the display area is set and a predetermined display target, such as a moving image, a logo, or the like, included in the content C11 is selected.

The changing unit 156 changes, in accordance with the operation performed by a user, a display mode of the content C11. For example, if the ratio occupied by the content C11 in the display area exceeds a predetermined threshold due to the scroll operation, the changing unit 156 starts to reduce the logo mark included in the content C11. Furthermore, if a scroll operation is performed when the display position is fixed, the changing unit 156 performs, in accordance with the direction or an amount of the subject scroll operation, the display, the movement, and the deletion of the character strings included in the content C11.

Furthermore, the changing unit 156 may also change the display mode of the content C11 by using a mode other than the mode described above. For example, if a moving image is included in the content C11, the changing unit 156 may also play back the moving image. Furthermore, the changing unit 156 may also change the shape, the color, the degree of transparency of the content C11. Furthermore the changing unit 156 may also change the display mode of the content C11, in accordance with a tap operation or the like in addition to the scroll operation. Furthermore, the changing unit 156 may also change the display mode of the content C11 in accordance with the physical state of the terminal device 100 measured by the physical sensor 140.

### 7. Variation in the Display Process

In the above, an example of the display process performed by the terminal device 100 has been described by using the display mode illustrated in FIG. 1. However, the embodiment is not limited thereto. In the following, a variation in the display process performed by the terminal device 100 will be described. The display process described below is implemented by a process performed by, for example, the displaying unit 155 or the changing unit 156; however, the embodiment is not limited thereto.

### 7-1. Amount of an Offset

The terminal device 100 described above shifts the display area in the downward direction of the combined content by the amount of an offset and displays the range included in the display area in the combined content as the initial screen. At this point, the terminal device 100 can use the amount of an offset indicated by an arbitrary value that is set by an advertiser.

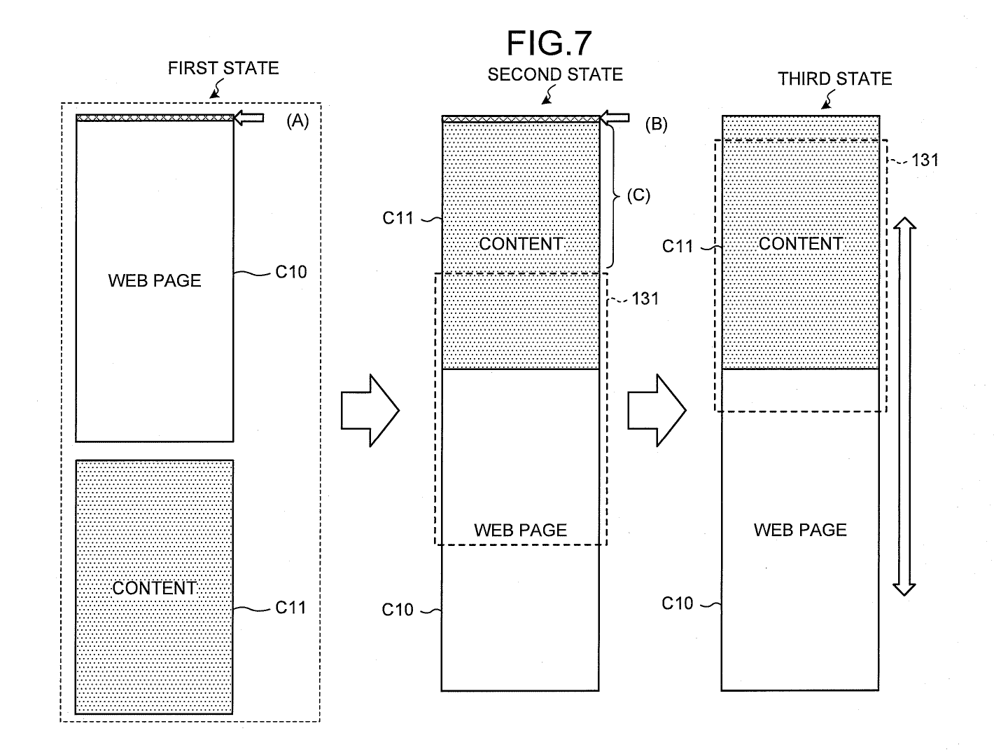

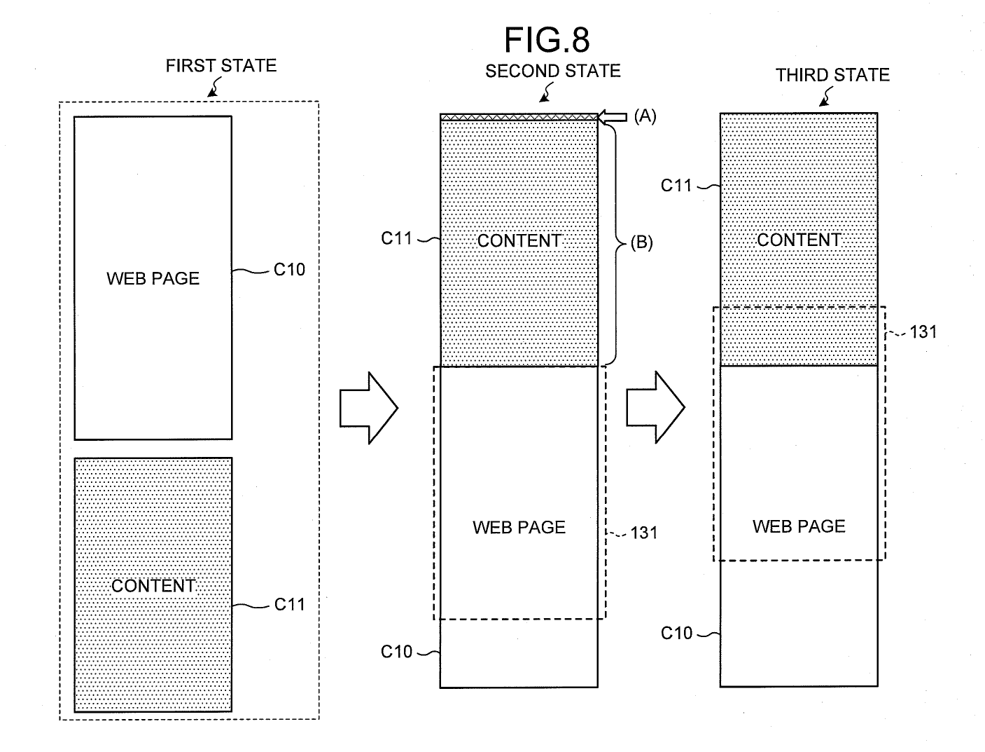

In the following, an example of the amount of an offset will be described with reference to FIGS. 7 and 8. FIG. 7 is a schematic diagram illustrating a first example of the amount of an offset used by the terminal device according to the embodiment. FIG. 8 is a schematic diagram illustrating a second example of the amount of an offset used by the terminal device according to the embodiment.

For example, as indicated by a first state illustrated in FIG. 7, the terminal device 100 receives distribution of the web page C10 and the content C11. In this case, on a normal browser, as indicated by (A) illustrated in FIG. 7, the web page C10 is displayed such that the upper end of the web page C10 matches the upper end of the screen. However, in this display mode, it is difficult to display the content C11 and thus it is not possible to provide a user with an awareness of the content C11.

Thus, as indicated by a second state illustrated in FIG. 7, the terminal device 100 creates combined content in which the web page C10 and the content C11 are arranged in a column such that the upper end of the web page C10 is brought into contact with the lower end of the content C11. In this case, by setting the upper end of the combined content indicated by (B) illustrated in FIG. 7 as the upper end of the display area 131 of the output unit 130, the browser tends to display the area included in the display area 131 in the combined content. Thus, the terminal device 100 displays the display area 131 such that the display area 131 is shifted to the lower side from the upper end of the combined content by the specified amount of an offset.

At this point, as indicated by (C) illustrated in FIG. 7, if the amount of an offset is smaller than the length from the upper end to the lower end of the content C11, the terminal device 100 displays the initial screen in which a part of the content C11 is arranged on the upper side of the screen and a part of the web page C10 is arranged on the lower side of the screen. Consequently, because the terminal device 100 simultaneously displays the web page C10 and the content C11 on the initial screen, the terminal device 100 can provide a user with an awareness of the content C11.

Furthermore, as indicated by a third state illustrated in FIG. 7, the terminal device 100 moves the display area 131 in accordance with the scroll operation performed by the user and changes the range of the combined content to be displayed on the screen. Consequently, the terminal device 100 can make the user interested in the content C11 to perform a scroll operation in the downward direction and display the content C11 in the range greater than the initial screen. Furthermore, the terminal device 100 can induce the user who wants to browse the web page C10 to perform a scroll operation in the upward direction and display the web page C10 in the range greater than the initial screen. Consequently, the terminal device 100 can improve the appeal of information related to the content C11 without degrading the impression obtained by the user.

In contrast, if the amount of an offset is greater than the length from the upper end to the lower end of the content C11, the terminal device 100 displays, as the initial screen, a part of the web page C10. For example, as indicated by the first state illustrated in FIG. 8, if the terminal device 100 receives the web page C10 and the content C11, the terminal device 100 creates combined content. Then, as indicated by the second state illustrated in FIG. 8, the terminal device 100 moves the upper end of the display area 131 from the upper end of the combined area indicated by (A) illustrated in FIG. 8 by the amount of an offset, indicated by (B) illustrated in FIG. 8, which is longer than the distance between the upper end and the lower end of the content C11. Consequently, the terminal device 100 displays only the web page C10 on the initial screen.

At this point, there may be a case in which, when a user browses the web page C10, the user unintentionally performs a scroll operation in the downward direction even if the upper end of the web page C10 has been displayed. In this case, as indicated by the third state illustrated in FIG. 8, the terminal device 100 moves the display area 131 to the upper side of the combined content. Consequently, because the terminal device 100 displays a part of the content C11, the terminal device 100 provides the user with an awareness of the content C11 and thus leads the user to the content C11.

Furthermore, in addition to the amount of an offset specified by the advertiser, the terminal device 100 may also display the initial screen obtained by shifting, for example, the display area by a predetermined amount. Furthermore, the terminal device 100 may also calculate the amount of an offset in accordance with the content of the content C11 or the displayed size and set the position, as the position of the upper end of the initial screen, shifted from the upper end of the content C11 to the lower side by the calculated amount of an offset.

Furthermore, the terminal device 100 may also change the amount of an offset in accordance with the size or the orientation of the screen. For example, the terminal device 100 receives a specification of the number of pixels “n pixels” as the amount of an offset used when the web page C10 or the content C11 is displayed by using a vertically long screen. Then, if the terminal device 100 displays the web page C10 and the content C11 by using the vertically long screen, the terminal device 100 shifts the upper end of the initial screen by the specified “n pixels”.

In contrast, if a user inclines the device in the horizontal direction and displays the web page C10 and the content C11 by using horizontally long screen, the terminal device 100 modifies the specified number of pixels “n pixels” in accordance with the aspect ratio of the screen. For example, if the ratio of the short side to the long side of the screen is “a:b”, the terminal device 100 may also shift the upper end of the initial screen by “(n×a)/b pixels”. Furthermore, the process of modifying the amount of an offset performed by the terminal device 100 is not limited to the method described above and the amount of an offset may also be modified by using another calculation method. Furthermore, the terminal device 100 may also separately receive the specification of the amount of an offset to be used when a vertically long screen is used and the specification of the amount of an offset to be used when a horizontally long screen is used.

### 7-2. About the Fixed Display Position

If the entire of the content C11 is displayed, the terminal device 100 described above fixes the display position of the combined content, whereas, if a predetermined operation is performed, the terminal device 100 releases the fixed display position. At this point, the terminal device 100 may also use an arbitrary operation as the operation of releasing the fixed display position.

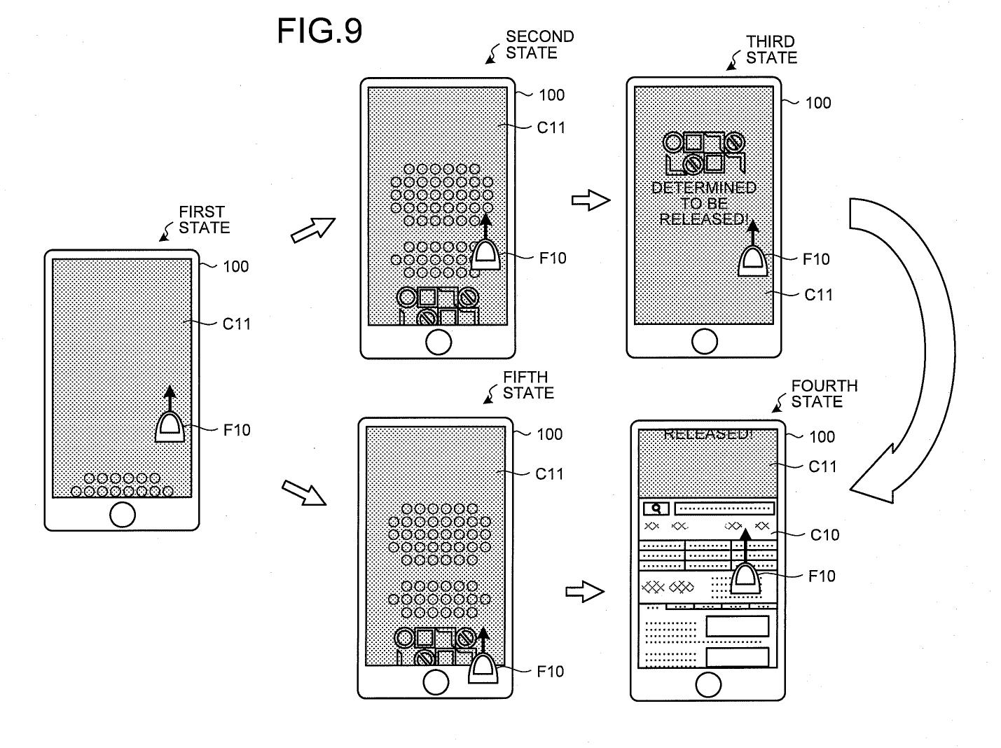

For example, FIG. 9 is a schematic diagram illustrating an example of a process in which the terminal device according to the embodiment releases fixing of a display position. For example, as indicated by the first state illustrated in FIG. 9, if the entire of the content C11 is displayed, the terminal device 100 fixes the display position of the combined content. Then, if a scroll operation in the upward direction is performed by the finger F10 of the user, the terminal device 100 does not change, as indicated by the second state illustrated in FIG. 9, the display position of the combined content and moves the character strings included in the content C11.

Furthermore, if a scroll operation in the upward direction is further performed by the finger F10 of the user, the terminal device 100 displays, as indicated by the third state illustrated in FIG. 9, the logo subsequent to the character strings. Then, if a scroll operation in the upward direction is further performed in the state in which the logo subsequent to the character strings is displayed, the terminal device 100 moves, as indicated by the fourth state illustrated in FIG. 9, the display area in the downward direction. Namely, by the operation performed by the user, if the display mode of the content C11 is displayed to the end and a scroll operation in the upward direction is further performed, the terminal device 100 releases the fixed display position and scrolls the combined content.

In contrast, as indicated by the fifth state illustrated in FIG. 9, if the display position is fixed and if the finger F10 of the user performs a scroll operation from the lower end toward the upward direction of the screen, the displaying unit 155 releases, as indicated by the fourth state illustrated in FIG. 9, the fixed display position and moves the combined content in accordance with the scroll operation. Furthermore, the terminal device 100 may also change the display mode of the content C11 or does not need to change the display mode of the content C11, depending on the scroll operation performed after the display position is fixed.

### 7-3. Playback of a Moving Image

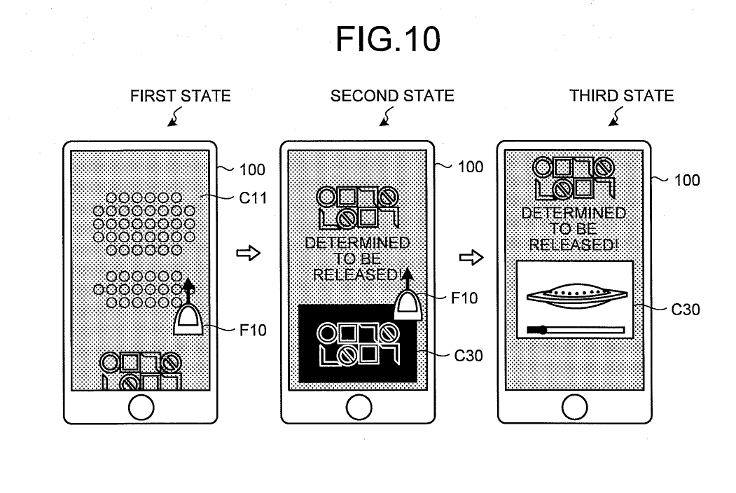

In the embodiment described above, the terminal device 100 displays the content C11 in which the display mode is changed in accordance with the operation performed by a user. At this point, the terminal device 100 may also display the content C11 that includes therein a moving image. For example, FIG. 10 is a schematic diagram illustrating a process in which the terminal device according to the embodiment displays content that includes therein a moving image. For example, as indicated by the first state illustrated in FIG. 10, if the entire of the content C11 is displayed, the terminal device 100 fixes the position of the display area and changes the display mode of the content C11 in accordance with the scroll operation.

At this point, the content C11 includes therein the content C30 of character strings and the moving image that are arranged under the logo. Thus, for example, as indicated by the second state illustrated in FIG. 10, the terminal device 100 scrolls, in accordance with a scroll operation performed by the user, the content C30 in the upward direction on the screen. Then, as indicated by the third state illustrated in FIG. 10, if the content C30 moves to the center of the screen, the terminal device 100 starts to play back the content C30.

Furthermore, the terminal device 100 may also start to play back the content C30 when a predetermined operation is performed. For example, if the logo included in the content C11 is tapped, the terminal device 100 may also display the content C30 and then start a playback. Furthermore, the terminal device 100 may also receive an operation of a playback or a pause of the content C30.

Furthermore, if a user taps the content C30, the terminal device 100 may also display a landing page. Furthermore, if the ratio occupied by the content C11 in the display area exceeds a predetermined threshold even if the position of the display area is not fixed, the terminal device 100 may also start to play back the content C30. For example, if the content C11 is displayed on the upper half of the screen due to a scroll operation, the terminal device 100 may also display the content C30 on the area in which the content C11 is displayed and may also start a playback. Furthermore, if a scroll operation in the downward direction is performed from the initial screen, the terminal device 100 may also start the display and the playback of the content C30.

### 7-4. About a Display Area

Here, if a scroll operation in the downward direction is performed when the initial screen is displayed and if the size of the area that is used to display the content C11 becomes large, it is conceivable that a user is interested in the content C11. Thus, if the ratio of the content C11 in the display area exceeds a predetermined threshold due to the scroll operation, the terminal device 100 may also automatically change the position of the display area before the entire of the content C11 is displayed. For example, if the content C11 is displayed in the area equal to or greater than 60% of the display area, the terminal device 100 may also move the display area until the content C11 is displayed on the entire of the display area and then may also fix the position of the display area.

### 7-5. About the Content C11

In the example described above, if a scroll operation in the upward direction is performed, the terminal device 100 displays the content C11 in which character strings are moved from the bottom to the top. However, the embodiment is not limited to this. For example, the terminal device 100 may also display, in accordance with a scroll operation in the horizontal direction, the content in which a character string, a pattern, an image, a moving image, or the like appears. Furthermore, the terminal device 100 may also display the content including a game or the like, i.e., the content including a playable advertisement. Furthermore, the terminal device 100 may also display the content including a sound. Furthermore, the character string, the pattern, the image, the moving image, the game, the sound, or the like included in the content C11 is not limited to that related to an advertisement.

### 7-6. Others

The terminal device 100 may also perform the display process by appropriately combining the processes described above. This combination can arbitrarily be set by an advertiser as a display instruction when the advertiser registers advertisement content in the advertisement distribution server 20. Then, the advertisement distribution server 20 creates control information that allows the terminal device 100 to perform the combination of the processes that are set by the advertiser and distributes the created control information to the terminal device 100. Consequently, the terminal device 100 can combine the arbitrary processes described above in accordance with the setting performed by the advertiser and perform the processes in combination.

### 8. Flow of the Process Performed by the Terminal Device 100

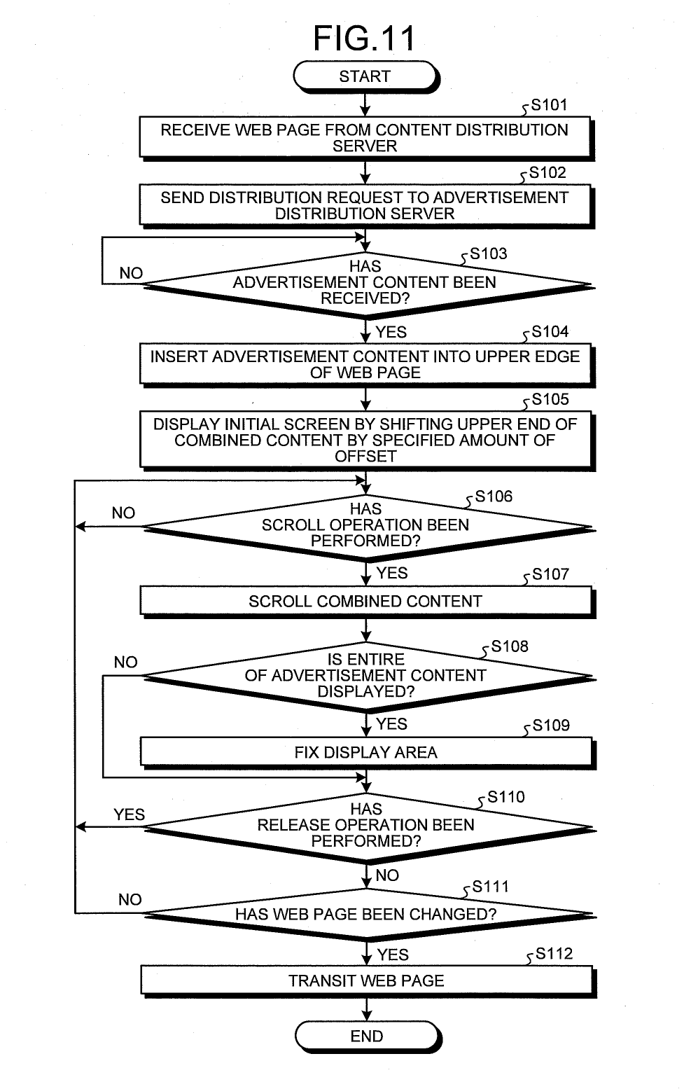

In the following, the flow of the process performed by the terminal device 100 that performs the control information will be described with reference to FIG. 11. FIG. 11 is a flowchart illustrating an example of the flow of a display process performed by the terminal device according to the embodiment. In the example illustrated in FIG. 11, the process will be described by using the content, such as the content C11 or the like, distributed from the advertisement distribution server 20 as advertisement content.

In the example illustrated in FIG. 11, the terminal device 100 requests the content distribution server 30 to distribute the web page C10 in accordance with the operation performed by a user and receives the web page C10 from the content distribution server 30 (Step S101). If an acquisition instruction is included in the distributed web page C10, the terminal device 100 sends the distribution request to the advertisement distribution server 20 (Step S102). Then, the terminal device 100 determines whether the terminal device 100 has received advertisement content (Step S103). If the terminal device 100 determines that the terminal device 100 has received advertisement content (No at Step S103), the terminal device 100 again performs the process at Step S103.

Furthermore, if the terminal device 100 has received the advertisement content (Yes at Step S103), the terminal device 100 inserts the advertisement content into the upper end of the web page C10 and creates combined content (Step S104). Then, the terminal device 100 displays, as an initial screen, the combined content by shifting the upper end of the combined content by a specified amount of an offset (Step S105).

Furthermore, the terminal device 100 determines whether a scroll operation has been performed (Step S106). If a scroll operation has been performed (Yes at Step S106), the terminal device 100 scrolls the combined content in accordance with the scroll operation (Step S107). Furthermore, the terminal device 100 determines whether the entire of the advertisement content is displayed (Step S108). If the entire of the advertisement content is displayed (Yes at Step S108), the terminal device 100 fixes the display area (Step S109).

Subsequently, the terminal device 100 determines whether a release operation that releases the fixed display area has been performed (Step S110). If the release operation has not been performed (No at Step S110), the terminal device 100 determines whether transition is to be performed on a web page by using a process in which a user taps a link (Step S111). Then, if the terminal device 100 transits the web page (Yes at Step S111), the terminal device 100 transits the web page (Step S112) and ends the process.

In contrast, if the terminal device 100 does not transit the web page (No at Step S111), the terminal device 100 performs the process at Step S107. Furthermore, if a release operation that releases the fixed display area is performed (Yes Step S110), the terminal device 100 performs the process at Step S106. Furthermore, if the entirety of the advertisement content is not displayed (No at Step S108), the terminal device 100 skips the process to be performed at Step S109. Furthermore, if the scroll operation is not performed (No at Step S106), the terminal device 100 again performs the process at Step S106.

### 9. Modification

In the description above, an example of the display process performed by the terminal device 100 using the display mode illustrated in FIG. 1 has been described. However, the embodiment is not limited thereto. In the following, a variation in the display process performed by the terminal device 100 will be described. The display process described below is implemented by the process performed by, for example, the arranging unit 154, the displaying unit 155, and the changing unit 156.

### 9-1. Overlapping Content

In the process described above, the terminal device 100 displays the web page C10 and the content C11 in a column such that the upper end of the web page C10 is brought into contact with the lower end of the content C11. However, the embodiment is not limited to this.

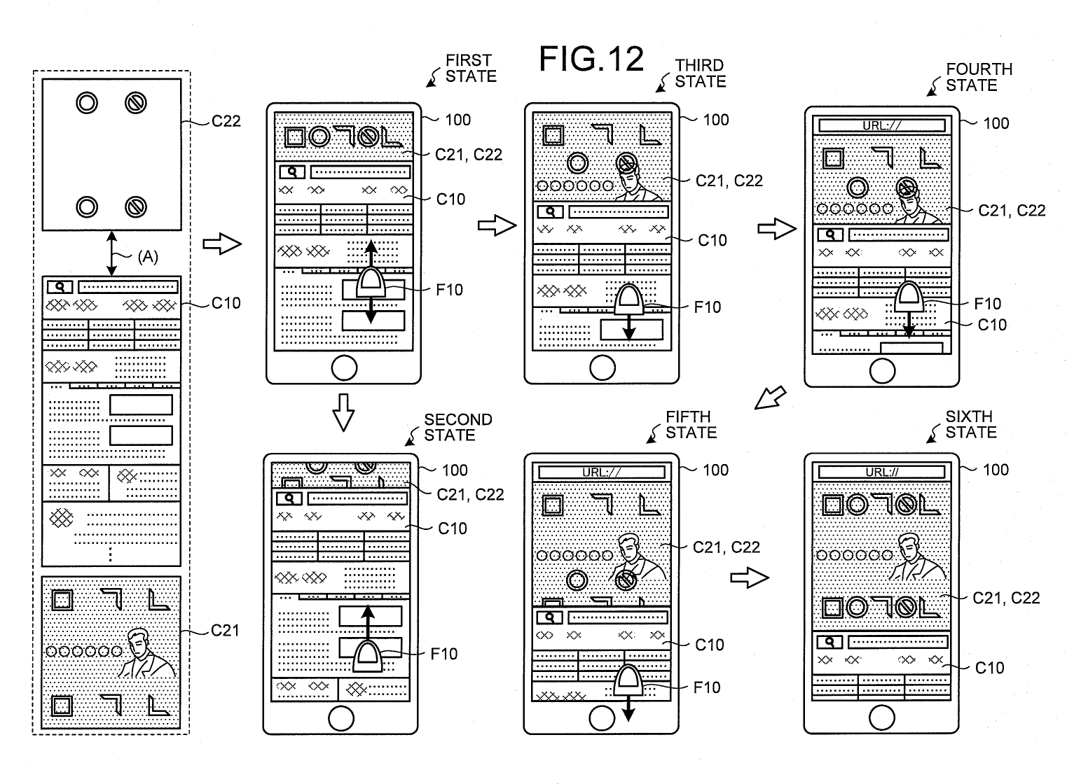

For example, FIG. 12 is a schematic diagram illustrating a process in which the terminal device according to the embodiment displays two pieces of content so as to overlap each other. For example, in the example illustrated in FIG. 12, the terminal device 100 receives distribution of the web page C10, content C21, and content C22. Here, the content C21 is content in which a part of the logo is arranged on the upper and the lower sides and an advertisement copy, photographs, and the like are arrange at the center. Furthermore, the content C22 is the content that is a transparent area in which, by combining with a part of the logo arranged in the content C21, a part of the logo that reproduces the entire logo is arranged on each of the upper side and the lower side and the rest of the area displays the back side of the content.

If the terminal device 100 receives distribution of the content C21 and the content C22, the terminal device 100 performs the following process. First, the terminal device 100 creates combined content in which the web page C10 and the content C22 that includes the transparent area are arranged in a column such that the upper end of the web page C10 is brought into contact with the lower end of the content C22. Then, the terminal device 100 sets the position away from the upper end of the combined content by the amount of an offset in the downward direction as the upper end of the display area of the combined content.

In contrast, the terminal device 100 arranges the content C21 on the back side of the combined content. Then, the terminal device 100 sets the upper end of the content C21 as the upper end of the display area of the content C21. Then, the terminal device 100 displays the initial screen in which the display area of the combined content and the display area of the content C22 are overlapped.

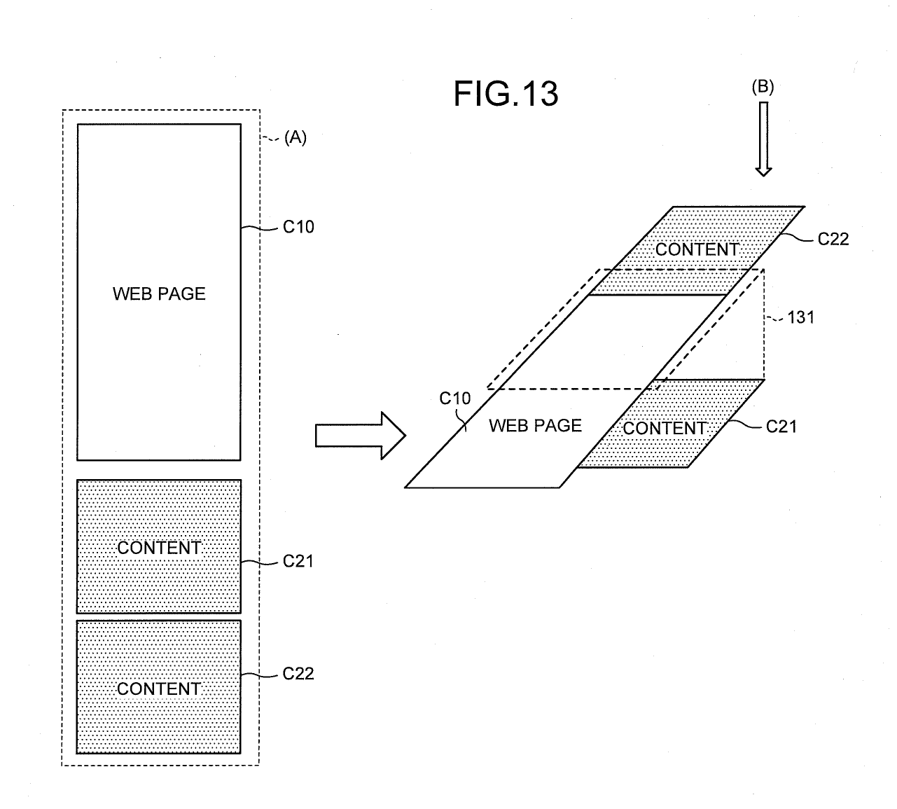

For example, FIG. 13 is a schematic diagram illustrating a process in which the terminal device according to the embodiment arranges the content. For example, as indicated by (A) illustrated in FIG. 13, if the terminal device 100 receives distribution of the web page C10, the content C21, and the content C22, the terminal device 100 performs the arrangement, as indicated by (B) illustrated in FIG. 13, such that the upper end of the web page C10 is brought into contact with the lower end of the content C22 and sets the position shifted from the upper end of the content C22 by the amount of an offset in the downward direction as the upper end of the display area 131.

Furthermore, the terminal device 100 arranges the content C21 on the back side of the web page C10 and the content C22 and sets the upper end of the content C21 as the upper end of the display area 131. Consequently, the terminal device 100 displays a part of the content C22 on the upper side of the screen, displays a part of the web page C10 on the lower side of the screen, and displays the content C21 that is arranged at the position in which the upper end of the content C21 matches, via the transparent area of the content C22, the upper end of the screen.

In the following, referring back to FIG. 12, a variation in the display process performed by the terminal device 100 will be described. In a description below, the variation in the display process performed by the terminal device 100 will be described by dividing the states into a first state to a sixth state.

First, as indicated by (A) illustrated in FIG. 12, the terminal device 100 creates combined content in which the web page C10 and the content C22 that has a transparent area are arranged such that the upper end of the web page C10 is brought into contact with the lower end of the content C22 and arranges the content C21 on the back side of the combined content. Then, the terminal device 100 sets the position away from the upper end of the combined content by the amount of an offset in the downward direction as the upper end of the display area of the combined content and sets the upper end of the content C21 as the upper end of the display area of the content C21.

Consequently, as indicated by the first state illustrated in FIG. 12, the terminal device 100 displays the web page C10 and displays the upper side of the content C21 via the transparent area of the content C22. Thus, the terminal device 100 displays the web page C10, the content C21, and the content C22 in a complicated mode in which a part of the logo arranged on the upper side of the content C21 is overlapped with the logo arranged on the lower side of the content C22 and a logo as if a single complete logo is displayed.

Here, if a scroll operation in the upward direction is performed in the first state illustrated in FIG. 12, the terminal device 100 may also scroll, as indicated by the second state illustrated in FIG. 12, the combined content in the upward direction without moving the display position of the content C21. If this process is performed, because the terminal device 100 displays the content C21 and the content C22 in a mode in which the logo displayed on the upper side of the screen is separated, the terminal device 100 can provide a user with an awareness of the content C21 and the content C22.

Furthermore, as indicated by the first state illustrated in FIG. 12, if a scroll operation in the upward direction is performed from the initial screen, the terminal device 100 may also move the combined content by a distance that is smaller than that at the normal time. Specifically, if a scroll operation in the upward direction is performed from the initial screen, the terminal device 100 moves the combined content by a distance that is smaller than the distance used when a scroll operation is performed when only the web page C10 is displayed. Consequently, because the terminal device 100 provides a user with an operation feeling that scrolling is more difficult than usual, the terminal device 100 can provide a user with an awareness of the content C21 and the content C22.

Furthermore, if a scroll operation is performed and thus the ratio of a displayed area in the content C21 is consequently reduced, the terminal device 100 may also change the display mode of the content C21 in accordance with the variation in the area in which the content C21 is displayed. For example, as the ratio of the area of the content C21 to be displayed is reduced, the terminal device 100 may also increase the brightness or the saturation of the content C21 or may also highlight the content C21 by, for example, surrounding the content C21 using a flashing frame. Furthermore, if the ratio of the area in which the content C21 is displayed is reduced, the terminal device 100 may also have a user pay an attention of the content C21.

Consequently, the terminal device 100 can make a user, who is not interested in the content C21, interested in the content C21 when the user performs a scroll operation in the upward direction from the initial screen. Thus, the terminal device 100 can make a user interested in the content C21 and the content C22. Consequently, the terminal device 100 can improve the appeal of information related to the content C21 and the content C22.

Furthermore, if a scroll operation in the downward direction is performed by the finger F10 of the user interested in the content C21 and the content C22, the terminal device 100 scrolls, in the downward direction, the combined content in which the web page C10 and the content C22 are arranged. In contrast, the terminal device 100 continuously displays the content C21 depending on a scroll operation. Consequently, as indicated by the third state illustrated in FIG. 12, the terminal device 100 increases the area of the content C21 displayed via the transparent area of the content C22 and changes the display mode in a complicated mode in which a part of the logo is moved in the downward direction in accordance with the scroll operation.

Here, if a scroll operation by an amount equal to or greater than a predetermined amount is performed, as indicated by the fourth state illustrated in FIG. 12, the terminal device 100 downwardly shifts the display position of both of the combined content and the content C21 and also displays the URL on the upper side of the screen. Furthermore, if a scroll operation in the downward direction is further performed, as indicated by the fifth state illustrated in FIG. 12, the terminal device 100 scrolls the combined content in the downward direction.

Then, after the scroll operation, if the upper end of the combined content consequently matches the upper end of the display area, the terminal device 100 ends the scroll operation of the combined content. Consequently, as indicated by the sixth state illustrated in FIG. 12, the terminal device 100 displays the content C21, the content C22, and the web page such that the upper ends thereof are overlapped. More specifically, the terminal device 100 displays the content C21 and the content C22 in a mode in which complete logos are arranged on the upper side and the lower side and advertisement characters, photographs, and the like are arranged at the center.

Furthermore, if a scroll operation in the upward direction is performed in the first state indicated by FIG. 12, the terminal device 100 scrolls the combined content and the content C21 in accordance with the scroll operation. Then, if the finger is separated, the terminal device 100 may also move the display position of each of the combined content and the content C21 until the upper ends of the combined content and the content C21 are overlapped with the upper end of the screen.

Furthermore, the terminal device 100 may also scroll the combined content and the content C21 in different modes in accordance with the scroll operation. For example, if a scroll operation in the upward direction is performed, the terminal device 100 may also move the combined content in the upward direction of the screen and may also move the content C21 in the downward direction of the screen. Furthermore, the terminal device 100 may also move the content C21 by a distance that is different from that used for the combined content. If this process is performed, the terminal device 100 can make a user interested in the content C21 and the content C22.

Furthermore, in addition to the logo, the terminal device 100 may also display the content C21 and the content C22 in which an arbitrary object, such as a character string, a pattern, a symbol, or the like, is arranged. Namely, the terminal device 100 may also display the content C21 in which a part of an object is arranged and the content C22 in which the other part of the object is arranged such that the entire of the object is displayed.

### 9-2. About the Mode of Advertisement Content

The terminal device 100 described above displays the content C11 in which the display mode varies in accordance with the operation performed by the user. Here, the variation in the display mode of the content C11 is not limited to the process described above and an arbitrary display mode can be used. Furthermore, in accordance with an operation performed by a user, the terminal device 100 may also change the display mode of the content C21 arranged on the back side of the combined content or change the display mode of the content C22 that includes a transparent area.

### 9-3. About an Advertisement

In the example described above, an example in which the terminal device 100 displays the content C11, the content C21, and the content C22 related to the advertisement has been described. However, the embodiment is not limited to this. Namely, the content C11 is not limited to the content related to the advertisement. For example, if game content is displayed instead of the web page C10, the terminal device 100 may also displays auxiliary content, such as a menu or a tutorial manual of a game, as the content C11, the content C21, and the content C22. Furthermore, the terminal device 100 may also perform the display process by displaying the content C11, the content C21, and the content C22 when the game is performed or when a web page in an interactive form created by a flash technology, a CSS technology, or the like. Furthermore, the terminal device 100 may also perform the display process described above by displaying the content C11, the content C21, and the content C22 together with content of a social networking service (SNS), a screen of a messenger application, a screen of a camera application, and other pieces of arbitrary content. Furthermore, in addition to the web page C10, the terminal device 100 may also display arbitrary content, such as a game, a map, a music reproduction screen, a moving image playback screen, or the like as the first content and the content C11, the content C21, and the content C22 that are an example of the second content.

### 9-4. About Control Information

The terminal device 100 described above performs the display process by using the control information that is distributed by the advertisement distribution server 20 together with the content C11. However, the embodiment is not limited to this. For example, the terminal device 100 receives the control information described above from the content distribution server 30 together with a web page and receives a control instruction from the advertisement distribution server 20 together with the content C11. Then, the terminal device 100 may also perform the control information received from the content distribution server 30 and perform the display process in accordance with the received control instruction.

Furthermore, the terminal device 100 may also perform the processes described above by previously downloading an application that causes the terminal device 100 to perform the display process on the web page C10 or to perform the process described above.

### 9-5. Configuration of the Device

Furthermore, in the embodiment described above, an example in which the advertisement distribution server 20 and the content distribution server 30 are included in the distribution system 1 has been described; however, the advertisement distribution server 20 and the content distribution server 30 may also be formed as a single device. In this case, the advertisement distribution server 20 illustrated in FIG. 3 includes, for example, the content storing unit 32, the receiving unit 34, and the distribution unit 35 illustrated in FIG. 5. Then, if the advertisement distribution server 20 receives an acquisition request of a web page from the terminal device 100, the advertisement distribution server 20 distributes, to the terminal device 100 together with the advertisement content, the web page that does not include an acquisition instruction.

Furthermore, in the embodiment described above, an example in which the content C11 is distributed from the advertisement distribution server 20 to the terminal device 100 has been described. However, the content distribution server 30 may also acquire the content C11 from the advertisement distribution server 20. In this case, the request receiving unit 26 in the advertisement distribution server 20 receives an acquisition request of the content C11 from the content distribution server 30. Furthermore, the advertisement distribution server 20 distributes the content C11 to the content distribution server 30. Furthermore, in addition to the content C11 acquired from the advertisement distribution server 20, the content distribution server 30 distributes the web page that does not include the acquisition instruction to the terminal device 100.

### 9-6. About a Log

Here, the terminal device 100 may also create a log indicating whether the content C11, the content C21, and the content C22 have been displayed or a log of the content selected by a user. Furthermore, in addition to the number of displays or selections of the content C11, the content C21, and the content C22, the terminal device 100 may also measure, for each image, the time selected by a user. Furthermore, the terminal device 100 may also create a log indicating whether the size of the display area of the content C11 has been increased from the initial state. Furthermore, the terminal device 100 may also create a log indicating whether all the content C11, the content C21, and the content C22 have been displayed. Furthermore, the terminal device 100 may also create a log indicating whether the content C30 included in the content C11 has been played back or a log indicating whether all of the display modes of the content C11 have been displayed in accordance with the operation performed by a user.

For example, if a user ends a display of the web page C10 without performing a scroll operation, the terminal device 100 may also acquire a log indicating that the content C11 is not browsed. In contrast, if a user performs a scroll operation in the downward direction from the initial screen and increase the display area of the content C11, the terminal device 100 may also acquire the log indicating that the content C11 has been displayed. Furthermore, the terminal device 100 may also create a log indicating whether a user has selected the content C11 or a log indicating the time at which the display mode of the content C11 is selected.

As described above, the log acquired by the terminal device 100 is a log useful when the number of impressions or a CTR of the content C11 is updated, when a charging process performed on the display of the content C11 is performed, and when an advertisement effect is reported to an advertiser. For example, if a scroll operation in the downward direction is performed from the initial screen, it is predicted that a user is interested in the content C11. In contrast, if a display mode of the content C11 is not changed or of a scroll operation in the upward direction is performed from the initial screen, it is predicted that a user browses the web page C10 without interested in the content C11. Furthermore, if the scroll operation is performed many times, it is predicted that a user is interested in the content C11 and changes the display modes many times. Thus, the log indicating that the display modes of the content C11 were changed or the log indicating the scroll operation after the initial screen may possibly become an indication of user's interest in the content C11.

Thus, the advertisement distribution server 20 may also update the number of impressions or change an amount of charged fee by using each of the acquired logs. For example, the advertisement distribution server 20 may also change an amount of charged fee in accordance with, after a scroll operation in the downward direction is performed from the initial image, whether the display area of the content C11 is increased, whether the display mode of the content C11 is changed, whether the content C30 is played back, or the number of times of the scroll operations.

Furthermore, the log acquired by the terminal device 100 may also be used for a change in the content arranged on the landing page. For example, if a user selects the content C11, the terminal device 100 may also selectively output a landing page in accordance with the size of the display area of the content C11 or in accordance with whether the display modes of the content C11 are changed to the end. Furthermore, the terminal device 100 may also acquire the same landing page; notify the server that distributes the landing page of the size of the display area of the content C11 or whether the display modes of the content C11 are changed to the end; and change the content arranged in the landing page.

### 9-7. Operation Record of the Terminal Device

Furthermore, the terminal device 100 described above may also send, to the advertisement distribution server 20, a record indicating the number of times a user operates the terminal device 100 with respect to the web page in which the content C11 according to the embodiment is arranged. Specifically, the terminal device 100 records the content of the scroll operation when the content C11 is arranged, the number of times of the scroll operation, the position of the content C11 selected by a user, the display mode of the content C11 at the time of selection, a playback state of the content C30, or the like.

Furthermore, the terminal device 100 may also record various kinds of operations performed by a user on the terminal device 100, such as the number of selections of the content C11, the number of times of reload, a sending operation from the terminal device 100 about the information that specifies the content C11 (for example, writing in an SNS or the like). Then, the terminal device 100 sends the information about the operation history to the advertisement distribution server 20.

In this case, the advertisement distribution server 20 aggregates the information about the operation histories distributed from the terminal device 100 and further acquires information obtained by analyzing the subject information. For example, the advertisement distribution server 20 acquires, together with the control information, the number of scroll operations performed on the web page C10, the number of display processes performed, the type of the displayed landing page, the type of the content arranged on a landing page, information in which indications of advertisement effect, such as CTRs, are compared, or the like, which are obtained in a case in which the content C11 is distributed and in a case in which the content C11 is not distributed.

Here, the operation history that is performed on the web page C10 when the content C11 is distributed together with the control information may possibly become an indication of an advertisement effect. Namely, on the web page in which the content C11 including the control information according to the embodiment is displayed, not only displaying of a web page (landing page) subsequent to the content C11 due to a click of the content C11 itself performed by a user but also the operation history itself indicating the number of operations performed by the user on the web page C10 (i.e., the number of changes of the display modes on the screen performed by the user) can be an indication of user's interest in the content C11.

For example, by comparing the number of times a user displays the entire of the content C11 after the user performs a scroll operation in the downward direction from the initial screen or by comparing the time period for which the user displays the entire of the content C11, the advertisement distribution server 20 can provide the indication of information that is tried to be delivered by the content C11 when the content C11 including the control information according to the embodiment is displayed, i.e., indication of the degree of user's interest in the advertisement. Accordingly, by sending the information related to the operation history of the terminal device 100 to the advertiser terminal 10, the advertisement distribution server 20 can provide a report that indicates the indication of the advertisement effect with respect to the web page C10 on which the content C11 according to the embodiment is displayed. Furthermore, the advertisement distribution server 20 may also send the information related to the operation history of the terminal device 100 or the logs to the advertiser terminal 10 without processing anything.

Consequently, the advertisement distribution server 20 can represent the usefulness of the display mode of the content C11 including the control information according to the embodiment in the terminal device 100.

### 9-8. Others

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings. For example, various kinds of information indicated in each of the drawings are not limited to the indicated information.

Furthermore, the components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the illustrated in FIG. 6 may also be integrated.

Furthermore, each of the embodiments described above can be appropriately used in combination as long as the processes do not conflict with each other. For example, the terminal device 100 may also highlights the content C11 in the first state illustrated in FIG. 1. Furthermore, if a scroll operation in the upward direction is performed, the terminal device 100 may also change the display mode of the content C11 or reduce the amount of scroll of the combined content.

### 9-9. Program

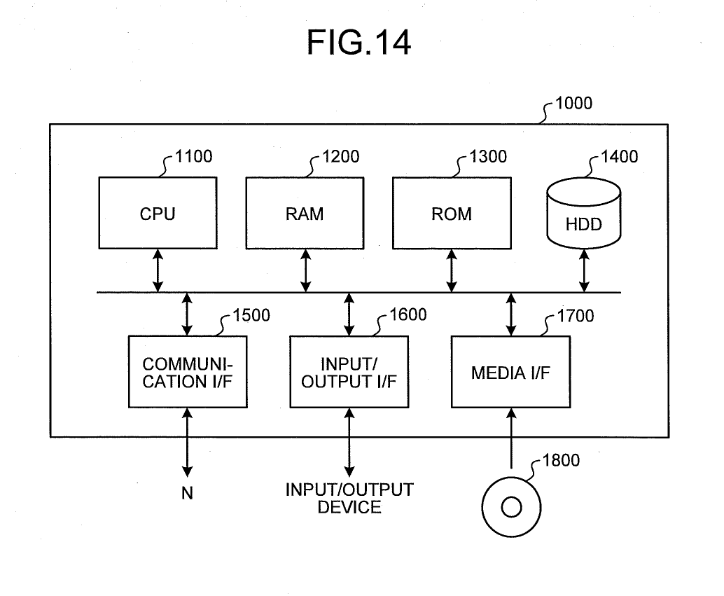

Furthermore, the terminal device 100, the advertisement distribution server 20, and the content distribution server 30 according to the embodiment described above are implemented by a computer 1000 having the configuration illustrated in, for example, FIG. 14. In the following, a description will be given using the advertisement distribution server 20 as an example. FIG. 14 is a hardware configuration diagram illustrating an example of a computer that implements the function performed by the advertisement distribution server. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates on the basis of a program stored in the ROM 1300 or the HDD 1400 and controls each of the units. The ROM 1300 stores therein a boot program that is executed by the CPU 1100 when the computer 1000 is started up, a program that depends on the hardware of the computer 1000, or the like.

The HDD 1400 stores therein a program executed by the CPU 1100, data that is used by the program, or the like. The communication interface 1500 receives data from other devices via the network N, sends the data to the CPU 1100, and sends data created by the CPU 1100 to other devices.

The CPU 1100 controls an output device, such as a display or a printer, and an input device, such as a keyboard or a mouse, via the input/output interface 1600. The CPU 1100 acquires data from the input device through the input/output interface 1600. Furthermore, the CPU 1100 outputs the created data to the output device through the input/output interface 1600.

The media interface reads a program or data stored in a recording medium 1800 and provides the program or the data to the CPU 1100 via the RAM 1200. The CPU 1100 loads the program on the RAM 1200 from the recording medium 1800 via the media interface and executes the loaded program. The recording medium 1800 is, for example, an optical recording medium, such as a digital versatile disc (DVD) or a phase change rewritable disk (PD), a magneto-optical recording medium, such as a magneto-optical disk (MO), a tape medium, a magnetic recording medium, a semiconductor memory, or the like.

For example, when the computer 1000 functions as the advertisement distribution server 20 according to the embodiment, the CPU 1100 in the computer 1000 executes the program loaded into the RAM 1200, thereby implementing the function performed by the control unit 23. Furthermore, the HDD 1400 stores therein data in the storing unit 22, i.e., the advertisement database 24. The CPU 1100 in the computer 1000 reads the programs from the recording medium 1800; however, as another example, the CPU 1100 may also acquire the programs from another device.

Furthermore, if the computer 1000 functions as the terminal device 100 according to the embodiment, the CPU 1100 in the computer 1000 executes the program loaded into the RAM 1200, thereby implementing the function performed by the control unit 150.

Furthermore, when the computer 1000 functions as the content distribution server 30 according to the embodiment, the CPU 1100 in the computer 1000 executes the program loaded into the RAM 1200, thereby implementing the function performed by the control unit 33. Furthermore, the HDD 1400 stores therein data in the content storing unit 32.

### 10. Effect

As described above, the terminal device 100 arranges the web page C10, which is an example of the first content, and the content C11, which is an example of the second content, in a column such that the upper end of the web page C10 is brought into contact with the lower end of the content C11. Then, the terminal device 100 displays the combined content at the position away from the upper end of the content C11 by a predetermined distance in the downward direction as the upper end of the combined content.

In this way, the terminal device 100 displays, on the initial screen, the content C11 together with the web page C10. Consequently, because the terminal device 100 can make the user aware of the presence of the content C11, the terminal device 100 can make a user interested in the content C11. Thus, the terminal device 100 can improve the appeal effect of the information related to the content C11.

More specifically, if the terminal device 100 displays the content C11 about an advertisement, because the terminal device 100 can make a user interested in the content C11 related to the advertisement, the terminal device 100 can improve the appeal of information to be delivered by the content C11, i.e., can improve the appeal of the content of the advertisement and consequently the terminal device 100 can improve the advertisement effect. Furthermore, because the terminal device 100 does not need a frame in which the web page C10 or the content C11 is displayed, the terminal device 100 reduces the processing load and thus implementing a smooth display.

Furthermore, when the terminal device 100 displays an initial screen when a display of the combined content is started, the terminal device 100 sets the position away from the upper end of the content C11 by a predetermined distance in the downward direction of the screen as the position of the upper end of the initial screen. Consequently, because the terminal device 100 can display the content C11 inside the initial screen, the terminal device 100 can improve the appeal effect of the information related to the content C11.

Furthermore, the terminal device 100 sets the position of the upper end of the content C11 in the downward direction by a distance smaller than the length from the upper end to the lower end of the content C11 as the position of the upper end of the initial screen. Consequently, the terminal device 100 can make a user aware of the presence of the content C11 on the initial screen.

Furthermore, the terminal device 100 sets the position of the upper end of the content C11 in the downward direction by a distance greater than the length from the upper end to the lower end of the content C11 as the position of the upper end of the initial screen.

Consequently, because the terminal device 100 displays the content C11 when a user unintentionally performs a scroll operation in the downward direction on the initial screen, the terminal device 100 can make a user interested in the content C11.

Furthermore, the terminal device 100 arranges the content C21, which is an example of the third content, on the back side of the web page C10 and the content C22, which is an example of the second content and includes a transparent area. Then, the terminal device 100 displays an initial image obtained from the display area, in which the upper end of the display area is set as the position away from the upper end of the content C22 by a predetermined distance in the downward direction, and the display area, in which the upper end of the display area is set as the upper end of the content C21. Consequently, because the terminal device 100 displays the content C21 and the content C22 in a complicated mode in which the content C21 can be transparently viewed on the back side of the content C22, the terminal device 100 can make a user interested in the content C21 and the content C22.

Furthermore, the terminal device 100 scrolls only the combined content in accordance with the scroll operation and does not scroll the content C21. Alternatively, the terminal device 100 scrolls the combined content in accordance with the scroll operation and scrolls the content C21 in a mode different from that used for the combined content. Accordingly, when a scroll operation is performed, some parallax occurs in the field of view of a user and, consequently, the terminal device 100 make a user interested in the content C21 and the content C22.

Furthermore, the terminal device 100 arranges the content C21 in which a part of the predetermined object is arranged and the content C22 in which another part of the object that is not included in the content C21 is arranged. Then, the terminal device 100 displays the content C21 and the content C22 so as to overlap each other when the terminal device 100 displays the initial screen. Consequently, the terminal device 100 can display the web page C10, the content C21, and the content C22 in a mode in which, for example, in an example illustrated in FIG. 12, a part of the logo arranged on the upper side of the content C21 and the logo arranged on the lower side of the content C22 are overlapped and the logo as if a single complete logo is displayed. Consequently, the terminal device 100 can improve the appeal of information related to the content C21 and the content C22. Furthermore, when a scroll operation is performed, the terminal device 100 scrolls the combined content in a manner in which a part of the object is shifted, which makes a user interested in the content C21 and the content C22.

Furthermore, if a scroll operation in the upward direction is performed from the initial screen, the terminal device 100 moves the combined content by a distance smaller than the distance when a scroll operation is performed in a state in which the initial screen is displayed. Consequently, because the terminal device 100 provides a user with an operation feeling that scrolling is more difficult than usual, the terminal device 100 can provide a user with an awareness of the content C21 and the content C22.

Furthermore, if a scroll operation is performed and the ratio of a displayed area in the content C21 is consequently reduced, the terminal device 100 changes the display mode of the content C21 in accordance with the variation in the area in which the content C21 is displayed. Consequently, if a user who is not interested in the content C21 performs a scroll operation in the upward direction from the initial screen, the terminal device 100 can make a user interested in the content C21.

Furthermore, the terminal device 100 displays the content C11 such that the display mode can be changed in accordance with the operation performed by a user. Consequently, because the terminal device 100 makes a user interested in the content C11, the terminal device 100 can improve the appeal of information related to the content C11.

Furthermore, the terminal device 100 displays the content C11 that includes therein the content C30 that is a moving image that is played back when a predetermined operation is performed. Consequently, because the terminal device 100 can make a user interested in the content C11, the terminal device 100 can improve the appeal of information related to the content C11.

Furthermore, the terminal device 100 moves the web page C10 and the content C11 in accordance with the operation performed by a user. Consequently, the terminal device 100 can make a user who is not interested in the content C11 browse the web page C10, whereas the terminal device 100 can display the content C11 for a user who is interested in the content C11. Consequently, the terminal device 100 can improve the appeal of information related to the content C11 while preventing the impression on the content C11 from being degraded.

Furthermore, if the ratio of the content C11 occupied in the screen exceeds a predetermined threshold, the terminal device 100 starts a playback of the moving image included in the content C11. Consequently, because the terminal device 100 can make a user interested in the content C11, the terminal device 100 can improve the appeal of information related to the content C11.

Furthermore, if the ratio of the content C11 occupied in the screen exceeds a predetermined threshold, the terminal device 100 changes the display positions of the web page C10 and the content C11 until the entire of the content C11 is displayed. Consequently, the terminal device 100 can display the entire of the content C11 for the user predicted to be interested in the content C11.

Furthermore, if the entire of the content C11 is displayed, the terminal device 100 fixes the display positions of the web page C10 and the content C11. Consequently, the terminal device 100 can improve the appeal of information related to the content C11.

Furthermore, if the terminal device 100 fixes the display position, the terminal device 100 changes the display mode of the content C11 in accordance with the scroll operation in the downward direction. Consequently, because the terminal device 100 can change the display mode of the content C11 in accordance with the scroll operation without moving the content C11, the terminal device 100 can improve the appeal of information related to the content C11.

Furthermore, if a predetermined operation is performed after the display position is fixed, the terminal device 100 releases the fixed display position. Consequently, because the terminal device 100 does not hinder a user from browsing the web page C10, the terminal device 100 prevents the impression on the content C11 from being degraded.

Furthermore, the terminal device 100 displays, when selected by a user, the content C11 that can be shifted to a predetermined content, such as a landing page or the like. Consequently, the terminal device 100 can improve the appeal of information related to the content C11, the associated landing page, or the like.

Furthermore, the advertisement distribution server 20 distributes the control information to the terminal device 100. The control information allows the terminal device to perform a process of arranging the web page C10 and the content C11 in a column such that the upper end of the web page C10 is brought into contact with the lower end of the content C11 that is different from the web page C10 and a process of displaying the initial screen that is set at the position away from the upper end of the content C11 by a predetermined distance in the downward direction as the upper end of the initial screen. Consequently, the advertisement distribution server 20 can improve the appeal of information related to the content C11.

In the above, embodiments of the present invention have been described; however the embodiments are described only by way of an example. In addition to the embodiment in disclosure of invention, various modifications and changes can be made in accordance with the knowledge of those skilled in the art.

Furthermore, the “components (sections, modules, units)” described above can be read as “means”, “circuits”, or the like. For example, the determination unit can be read as a determination means or a determination circuit.

According to an aspect of an embodiment, an advantage is provided in that appeal effect of information related to content can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information display device comprising:
an arranging unit that arranges, in a column, first content and second content that is different from the first content such that an upper end of the first content is brought into contact with the lower end of the second content, and
a displaying unit that displays the first content and the second content at the position away from the upper end of the second content by a predetermined distance in the downward direction as the position of the upper end of a display area.

2. The information display device according to claim 1, wherein, when the displaying unit displays an initial screen that is displayed when a display of the first content and the second content is started, the displaying unit sets the position away from the upper end of the second content by a predetermined distance in the downward direction as the position of the upper end of the display area.

3. The information display device according to claim 1, wherein the displaying unit sets the position away from the upper end of the second content by a distance that is smaller than a length from the upper end to the lower end of the second content in the downward direction as the position of the upper end of the display area when the first content and the second content are displayed.

4. The information display device according to claim 1, wherein the displaying unit sets the position away from the upper end of the second content by a distance that is greater than a length from the upper end to the lower end of the second content in the downward direction as the position of the upper end of the display area when the first content and the second content are displayed.

5. The information display device according to claim 1, wherein
the arranging unit arranges third content on the back side of the first content and the second content that includes a transparent area, and
the displaying unit displays a screen, which is set at the position away from the upper end of the second content by a predetermined distance in the downward direction as the position of the upper end of the screen, and a screen, which is set at the position of the upper end of the third content as the position of the upper end of the screen, so as to overlap each other.

6. The information display device according to claim 5, wherein, in accordance with an operation performed by the user, a displaying unit moves the first content and the second content and does not move the third content.

7. The information display device according to claim 5, wherein, in accordance with an operation performed by the user, a displaying unit moves the first content and the second content and moves the third content in a mode that is different from modes used for the first content and the second content.

8. The information display device according to claim 5, wherein
the arranging unit arranges the second content in which a part of a predetermined object is arranged and the third content in which a portion that is another part of the predetermined object and that is not arranged in the second content is arranged, and
when the displaying unit displays an initial screen that is displayed when a display of the first content and the second content is started, the displaying unit displays the second content and the third content so as to overlap each other such that the predetermined object appears.

9. The information display device according to claim 5, wherein, when a movement operation that moves the first content and the second content in the upward direction in a state in which the initial screen that is displayed when a display of the first content and the second content is started is performed, the displaying unit moves the first content and the second content by a distance smaller than that used when the movement operation is performed in a state in which the initial screen is not displayed.

10. The information display device according to claim 5, wherein, when the first content and the second content are moved due to an operation performed by the user and an area in which the third content is displayed is consequently reduced, the displaying unit changes a display mode of the third content in accordance with a variation in the area in which the third content is displayed.

11. The information display device according to claim 1, wherein the arranging unit arranges the second content in which a display mode can be changed in accordance with the operation performed by the user.

12. The information display device according to claim 1, wherein the arranging unit arranges the second content that includes therein a moving image that is played back when a predetermined operation is performed.

13. The information display device according to claim 1, wherein the displaying unit moves the first content and the second content in accordance with the operation performed by the user.

14. The information display device according to claim 1, wherein, when the ratio of the second content occupied in a screen exceeds a predetermined threshold, the displaying unit starts to play back the moving image included in the second content.

15. The information display device according to claim 1, wherein, when the ratio of the second content occupied in the screen exceeds the predetermined threshold, the displaying unit moves the first content and the second content until the entire of the second content is displayed.

16. The information display device according to claim 1, wherein, when the entire of the second content is displayed, the displaying unit fixes the display positions of the first content and the second content.

17. The information display device according to claim 16, wherein, when the display positions are fixed, the displaying unit changes the display mode of the second content in accordance with a scroll operation that moves the area in the downward direction.

18. The information display device according to claim 16, wherein, when a predetermined operation is performed after the display positions are fixed, the displaying unit releases the display positions that are fixed.

19. The information display device according to claim 1, wherein, the displaying unit displays the second content that can be changed to a predetermined content when the user selects the second content.

20. A distribution device comprising a distribution unit that distributes control information to a terminal device that displays first content and second content that is different from the first content, wherein
the control information causes the terminal device to execute:
arranging the first content and the second content in a column such that the upper end of the first content is brought into contact with the lower end of the second content that is different from the first content, and
displaying the first content and the second content at the position away from the upper end of the second content by a predetermined distance in the downward direction as the position of the upper end of a display area.

21. An information display method performed by an information display device, the information display method comprising:
arranging first content and second content that is different from the first content in a column such that the upper end of the first content is brought into contact with the lower end of the second content; and
displaying the first content and the second content at the position away from the upper end of the second content by a predetermined distance in the downward direction as the position of the upper end of a display area.

22. A non-transitory computer readable storage medium having stored therein an information display program causing a computer to execute a process comprising:
arranging first content and second content that is different from the first content in a column such that the upper end of the first content is brought into contact with the lower end of the second content; and
displaying the first content and the second content at the position away from the upper end of the second content by a predetermined distance in the downward direction as the position of the upper end of a display area.
